(19) United States
(12) Patent Application Publication
(10) Pub. No.: US 2015/0123890 A1
(43) Pub. Date: May 7, 2015

(54) TWO HAND NATURAL USER INPUT

(71) Applicant: Microsoft Corporation, Redmond, WA (US)

(72) Inventors: Jay Kapur, Redmond, WA (US); Mark Schwesinger, Bellevue, WA (US); Emily Yang, Seattle, WA (US); Sergio Paolantonio, Seattle, WA (US); Christian Klein, Duvall, WA (US)

(73) Assignee: Microsoft Corporation, Redmond, WA (US)

(21) Appl. No.: 14/071,421

(22) Filed: Nov. 4, 2013

(51) Int. Cl. G06F 3/01; G06F 3/00

(52) U.S. Cl. CPC G06F 3/017; G06F 3/005; G06F 3/011
USPC 345/156

(57) ABSTRACT

Embodiments are disclosed which relate to two hand natural user input. For example, one disclosed embodiment provides a method comprising receiving first hand tracking data regarding a first hand of a user and second hand tracking data regarding a second hand of the user from a sensor system. The first hand tracking data and the second hand tracking data temporally overlap. A gesture is then detected based on the first hand tracking data and the second hand tracking data, and one or more aspects of the computing device are controlled based on the gesture detected.

### BACKGROUND

Natural user inputs (NUI) are increasingly used as methods of interacting with a computing system. NUIs may comprise gestural input and/or voice commands, for example. In some approaches, gestures may be used to control aspects of an application running on a computing system. Such gestures may be detected by various sensing techniques, such as image sensing, motion sensing, and touch sensing.

### SUMMARY

Embodiments are disclosed that relate to detecting two hand natural user inputs. For example, one disclosed embodiment provides a method comprising receiving first hand tracking data regarding a first hand of a user and second hand tracking data regarding a second hand of the user from a sensor system, wherein the first hand tracking data and the second hand tracking data temporally overlap. A gesture is then detected based on the first hand tracking data and the second hand tracking data, and one or more aspects of the computing device are controlled based on the gesture detected.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example environment in which NUI is used to control a computer system in accordance with an embodiment of the disclosure.

FIG. 2 schematically shows aspects of an example virtual skeleton in accordance with an embodiment of this disclosure.

FIG. 3 shows a flowchart illustrating a method for detecting gestural input in accordance with an embodiment of the disclosure.

FIG. 4A-9E show example gestures in accordance with an embodiment of this disclosure.

FIG. 10 shows a block diagram of a computing device in accordance with an embodiment of this disclosure.

### DETAILED DESCRIPTION

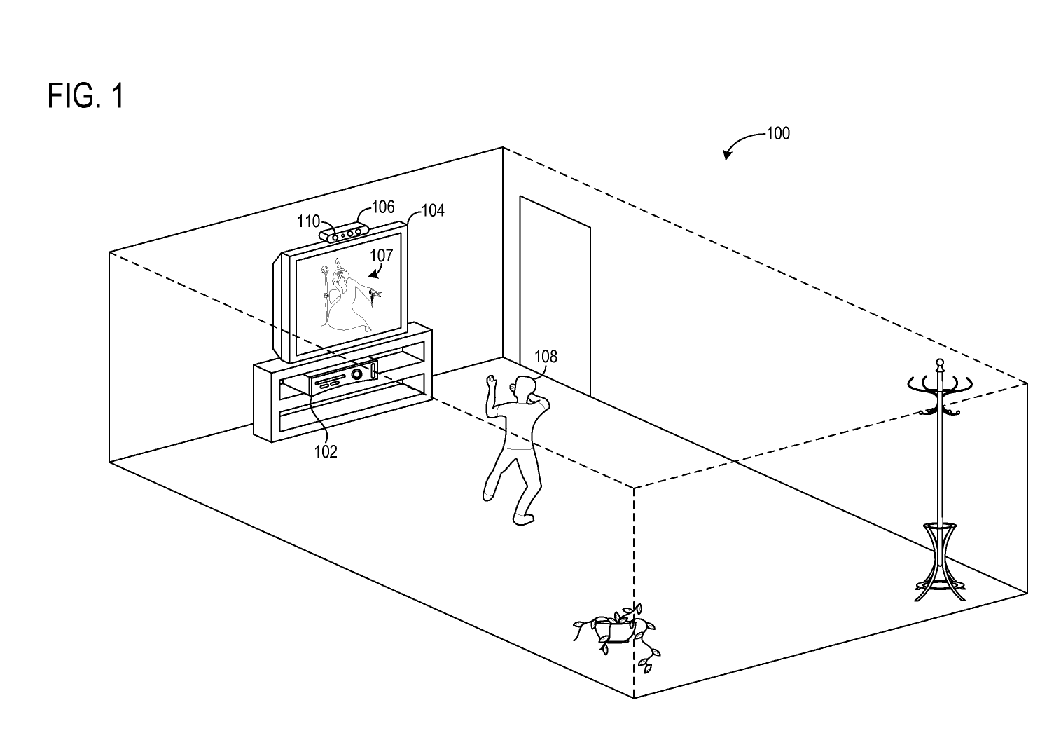

FIG. 1 shows aspects of an example NUI use environment 100. In the depicted example, environment 100 corresponds to a home entertainment environment. However, the embodiments described herein may be used in any other suitable environment, including but not limited to medical settings in which training, rehabilitation, and surgery are performed, manufacturing environments, museums, classrooms, etc.

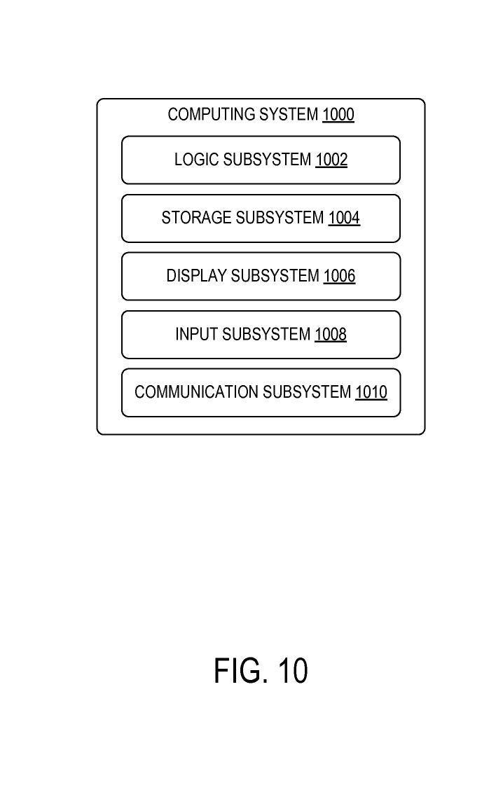

Environment 100 includes a computing system 102 to which a display device 104 and a sensor system 106 are operatively coupled. In some embodiments, computing system 102 may be a videogame console or a multimedia device configured to facilitate consumption of multimedia (e.g., music, video, etc.). In other embodiments, computing system 102 may be a general-purpose computing device, or may take any other suitable form. Example hardware which may be included in computing system 102 is described below with reference to FIG. 10. Computing system 102 may be operatively coupled to display 104 and sensor system 106 via any suitable wired or wireless communication link.

Computing system 102 is configured to accept various forms of user input from one or more users 108. As such, traditional user-input devices such as a keyboard, mouse, touch-screen, gamepad, or joystick controller (not shown in the drawings) may be operatively coupled to computing system 102. Computing system 102 is also configured to accept natural user input (NUI) from at least one user. NUI input may comprise gesture input and/or vocal input from user 108, for example. As shown in the illustrated example, user 108 is performing a NUI in the form of hand gestures to computing system 102, thereby affecting aspects of a game application 107 running on the computing system.

Display device 104 is configured to output visual content received from computing system 102, and also may output audio content. Display device 104 may be any suitable type of display, including but not limited to a liquid-crystal display (LCD), organic light-emitting diode (OLED) display, cathode ray tube (CRT) television, etc. While shown in the depicted example as a large-format display, display 104 may assume other sizes, and may comprise two or more displays. Other types of display devices, including projectors and mobile device displays, are also contemplated.

Sensor system 106 facilitates reception of NUI by tracking one or more users 108. Sensor system 106 may utilize a plurality of tracking technologies, including but not limited to time-resolved stereoscopy, structured light, and time-of-flight depth measurement. In the depicted example, sensor system 106 includes at least one depth camera 110 configured to output depth maps having a plurality of pixels. Each pixel in a depth map includes a depth value encoding the distance from the depth camera to a surface (e.g., user 108) imaged by that pixel. In other embodiments, depth camera 110 may output point cloud data having a plurality of points each defined by a three-dimensional position including a depth value indicating the distance from the depth camera to the surface represented by that point. While shown as a device separate from computing system 102 and placed atop display device 104, sensor system 106 may be integrated with the computing system, and/or placed in any other suitable location.

In the depicted example, sensor system 106 collects first hand tracking data of a first hand of user 108, and second hand tracking data of a second hand of the user. By simultaneously tracking both hands of user 108, a potentially larger range of hand gestures may be received and interpreted by computing system 102 than where single hand gestures are utilized. As described in further detail below, such hand gestures may comprise simultaneous input from both hands of user 108, as well as non-simultaneous (e.g., temporally separated) input from both hands of the user. Further, tracking both hands of a user also may be used to interpret a single hand gesture based upon contextual information from the non-gesture hand. As used herein, a “two hand gesture” refers to a gesture which includes temporally overlapping input from both hands, while a “one hand gesture” refers to a gesture which the gesture intended to be used as input us performed by a single hand. The term “simultaneous” may be used herein to refer to gestures of both hands that are at least partially temporally overlapping, and is not intended to imply that the gestures start and/or stop at a same time.

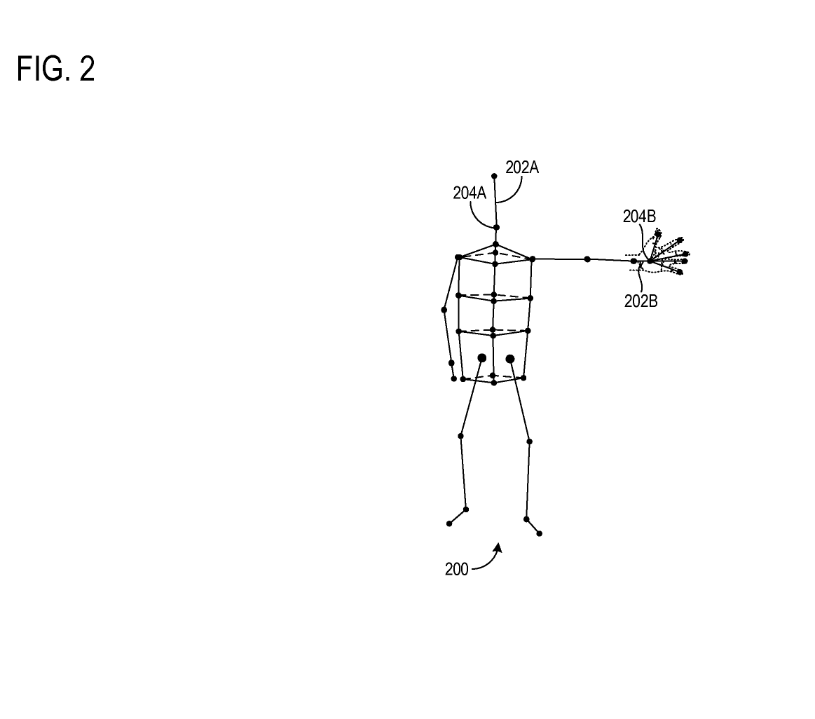

Any suitable methods may be used to track the hands of a user. For example, depth imagery from sensor system 106 may be used to model a virtual skeleton based upon user posture and movement. FIG. 2 schematically shows an example virtual skeleton 200 modeling user 108 based on tracking data received from sensor system 106. Virtual skeleton 200 may be assembled based on depth maps or point cloud data received from the sensor system. In the illustrated example, virtual skeleton 200 includes a plurality of skeletal segments 202 pivotally coupled at a plurality of joints 204. In some embodiments, a body-part designation may be assigned to each skeletal segment and/or each joint. For example, the body-part designation for skeletal segment 202A may correspond to the head of user 108, while the body-part designation for skeletal segment 202B may correspond to the wrist of the user. Likewise, joint 204A may be designated a neck joint, while joint 204B may be designated a hand joint. Virtual skeleton 200 further includes a skeletal segment and joint for each finger of each hand of the user (shown for the left hand). As such, virtual skeleton 200 may provide both hand and finger tracking data. It will be understood, however, that the number and arrangement of the skeletal segments and joints shown in FIG. 2 are not intended to be limiting in any way. In some embodiments, a virtual skeleton comprising skeletal segments and joints only for the hands and arms of the user may be assembled to facilitate hand tracking.

A plurality of parameters may be assigned to each joint 204 in virtual skeleton 200. These parameters may include position and rotational orientation respectively encoded via Cartesian coordinates and Euler angles, for example. Joint positions may be tracked over time and at a relatively high frequency (e.g., 30 frames per second) to facilitate tracking of a human subject in real-time. Further, one or more of the position, rotational orientation, and motion of two or more joints may be collectively tracked (or averaged for a single net joint) to determine a geometric posture of a portion of virtual skeleton 200. For example, hand postures such as an

“OK” posture and a “thumbs-up” posture may be recognized, in addition to hand states such as an open and a closed state, which respectively indicate whether a hand is open or closed.

By tracking the position and posture of both hands of user 108 over time, and in some embodiments additional parameters, a wide variety of aspects of computing system 102 may be controlled by a rich collection of gestures. The meaning of a given gesture—i.e., the action mapped to the gesture which affects computing system 102 in some manner—may be derived from hand state (e.g., open, closed), whether motion between each hand is symmetric or asymmetric, whether motion in one hand is accompanied or preceded by a static posture held by the other hand, etc. Thus, gesture meanings may be derived from one or more the position, motion, and posture of each hand in relation to each other and their change over time.

In addition to increasing the number of available gestures, simultaneously tracking two hands may also afford an increase in the quality of one hand gesture detection and interpretation. In some approaches, tracking data for a first hand may be used to prove context for the interpretation of tracking data of a second hand. For example, the first hand may be identified as performing a known, one hand gesture. Conversely, the second hand may be moving asymmetrically relative to the first hand in a manner that does not map to a known gesture, whether as a one hand gesture or a two hand gesture in combination with the first hand. As the second hand is undergoing significant motion which does not map to a known gesture, it may be assumed that the user did not intend on gestural interaction and is merely making movements which are random or intended for something or someone else, as one hand gestures may be performed deliberately, and thus when holding the other hand relatively still. In this way, erroneous gesture interpretation, and the action(s) thereby effected, may be prevented.

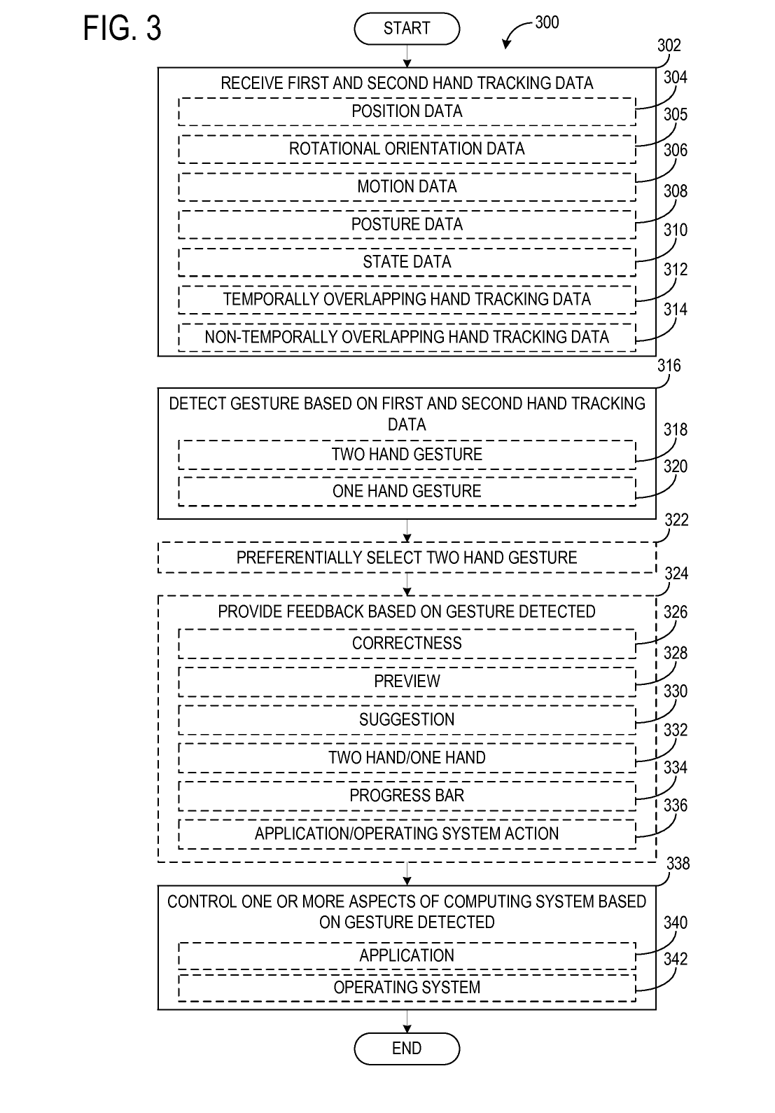

FIG. 3, a flowchart illustrating a method 300 for detecting gestural input in accordance with an embodiment of the present disclosure is shown. Method 300 may be executed on computing system 102 with tracking data received from sensor system 106, for example, and may be implemented as machine-readable instructions on a storage subsystem and executed by a logic subsystem. Examples of suitable storage and logic subsystems are described below with reference to FIG. 10.

At 302, method 300 comprises receiving from a sensor system first hand tracking data regarding a first hand of a user temporally overlapping second hand tracking data regarding a second hand of the user. Receiving the first and second hand tracking data may include receiving position data at 304, rotational orientation data at 305, motion data at 306, posture data at 308, and/or state data at 310. In some embodiments, position and motion data may be received for one or more hand joints in each hand of a virtual skeleton, while posture and state data may be received for some or all of the hand joints in each hand. Receiving first and second hand tracking data may further include receiving temporally overlapping hand tracking data at 312 and non-temporally overlapping hand tracking data at 314. Temporally overlapping hand tracking data may be used to detect and interpret simultaneous two hand gestures in which input from both hands is simultaneously supplied. Alternatively or additionally, non-temporally overlapping hand tracking data may be used to inform gesture detection and interpretation with preceding hand tracking data. For example, a hand gesture comprising a static posture followed by hand motion may be identified using non-temporally overlapping hand tracking data.

Next, at 316, method 300 comprises detecting one or more gestures based on the first and second hand tracking data received at 302. Gesture detection may include detecting one or more two hand gestures at 318 and may further include detecting one or more one hand gestures at 320, wherein one hand gestures may be detected via two hand tracking. Example one and two hand gestures are shown and described below. Depending on the parameters included in the received tracking data, one or more of the position, rotational orientation, motion, posture, and state of each hand may be used to find a matching gesture in a dictionary of known gestures.

In some scenarios, both a one hand gesture and a two hand gesture may be detected based on received hand tracking data. A variety of approaches may be employed to select whether to interpret the detected gesture as a one hand gesture or two hand gesture. One example optional approach may be to preferentially select the two hand gesture, as indicated at 322. Such an assumption may be made based upon the likelihood that the user intended to perform the two hand gesture, rather than perform a one hand gesture accompanied by hand input that unintentionally resembles the two hand gesture. Other approaches are possible, however, including preferentially selecting the one hand gesture, prompting the user for additional feedback to clarify whether the one or two hand gesture was intended, and utilizing confidence data regarding how closely each detected gesture resembles the corresponding identified system gesture.

Next, at 324, method 300 may comprise optionally providing feedback based on the gesture detected (or preferentially selected) at 316 (322). For example, visual feedback may be provided to the user via a display device operatively coupled to the computing system executing method 300. Providing feedback may include indicating the correctness of the gesture at 326, previewing an action to which the gesture maps at 328, suggesting a subsequent gesture or next step of the currently detected gesture at 330, indicating whether the currently detected gesture is a two hand gesture and/or a one hand gesture at 332, drawing a progress bar illustrating the progress toward completion of the gesture at 334, and/or indicating whether the action that the gesture maps to controls an aspect of an application or an OS running on the computing system at 336. It will be understood that these specific forms of feedback are described for the purpose of example, and are not intended to be limiting in any manner.

Continuing, method 300 comprises, at 338, controlling one or more aspects of a computing system based on the detected gesture. Such controlling may include, but is not limited to, controlling one or more aspects of the application at 340, and controlling one or more aspects of an operating system (OS) at 342.

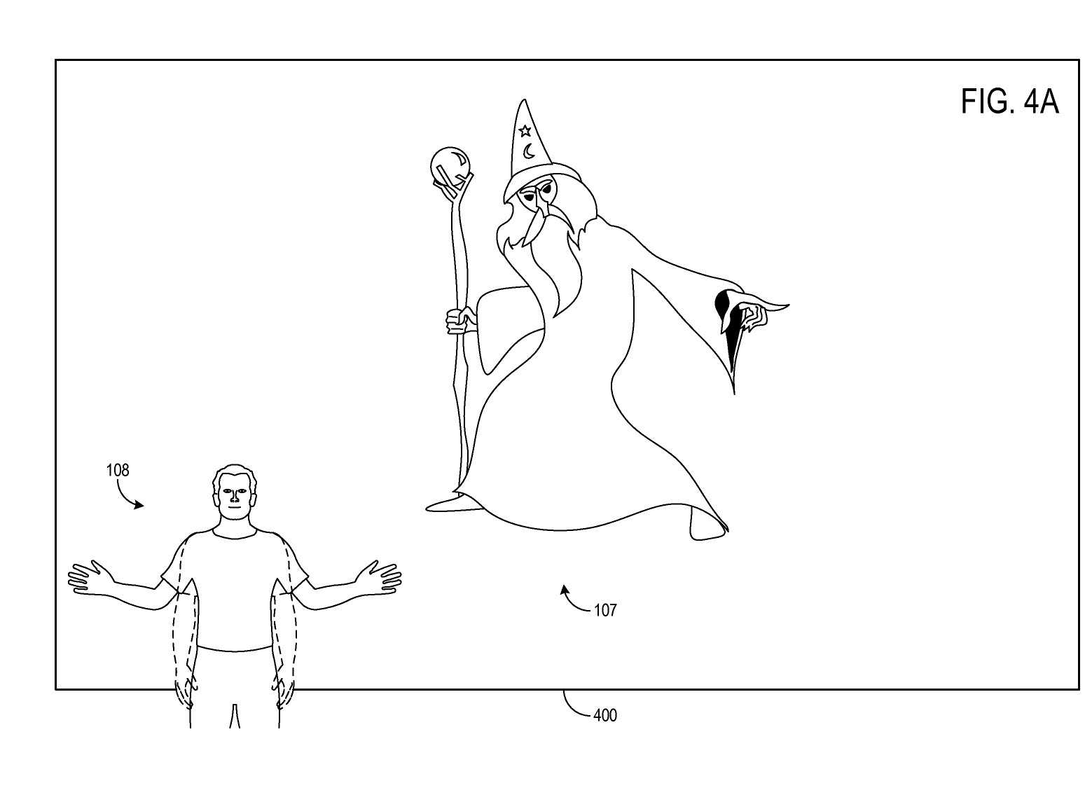

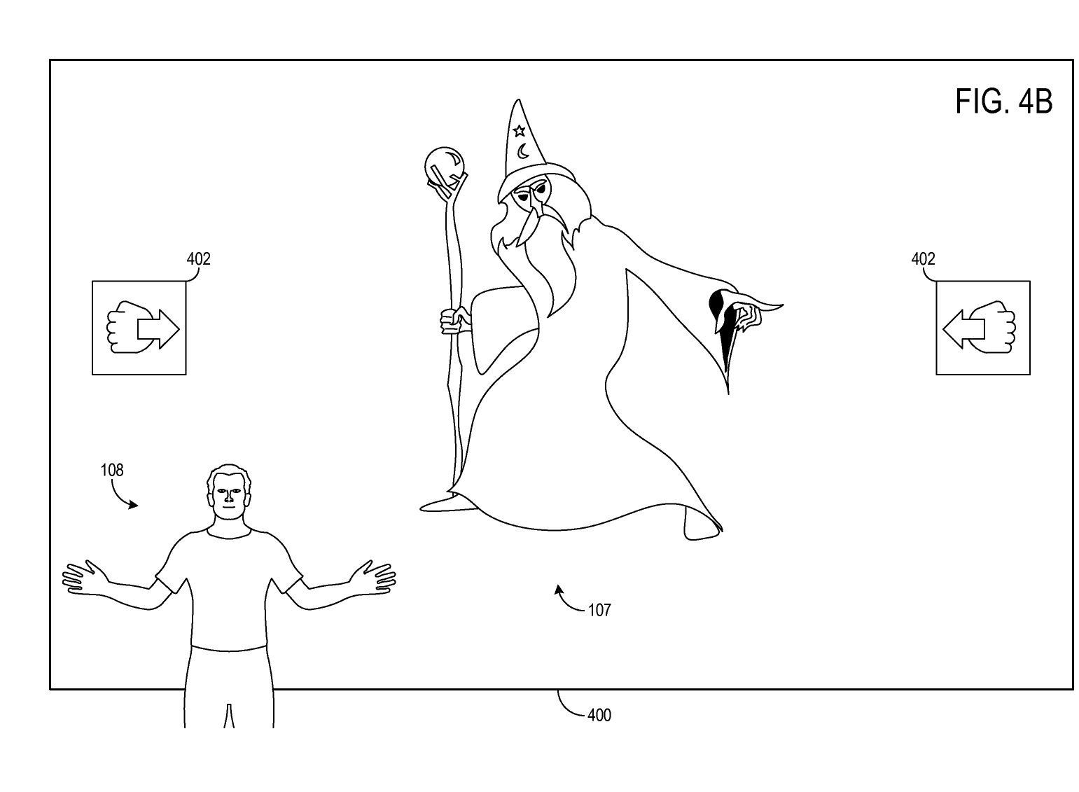

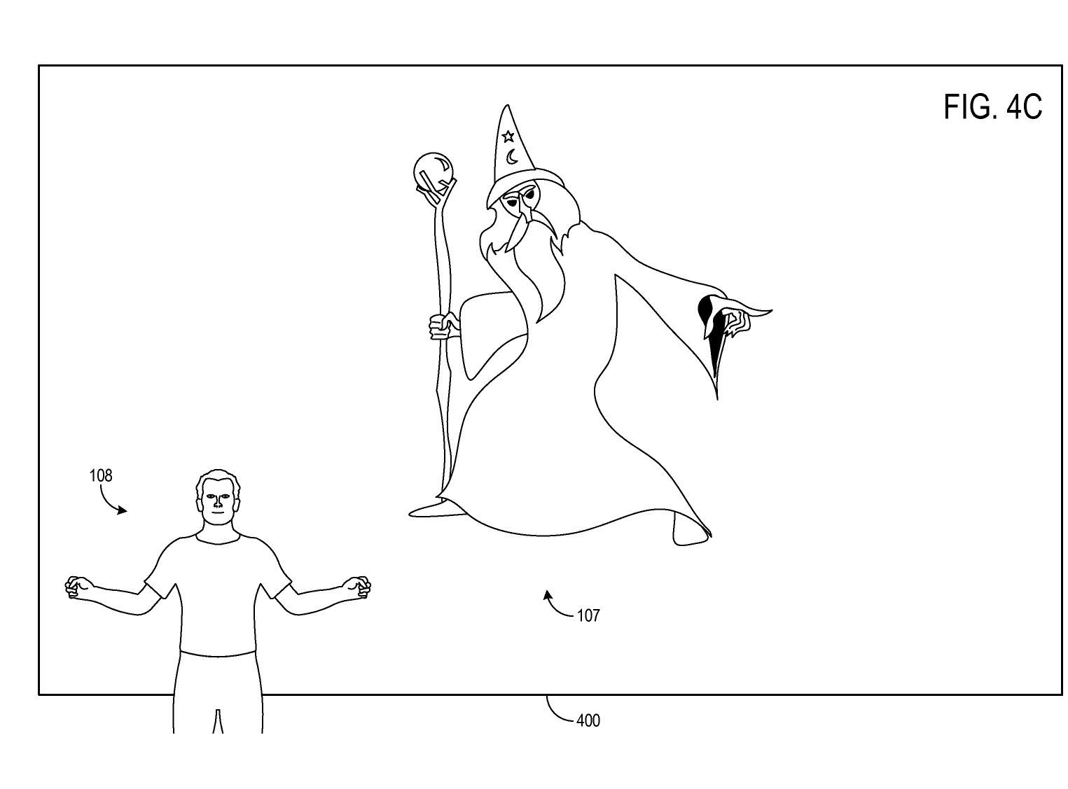

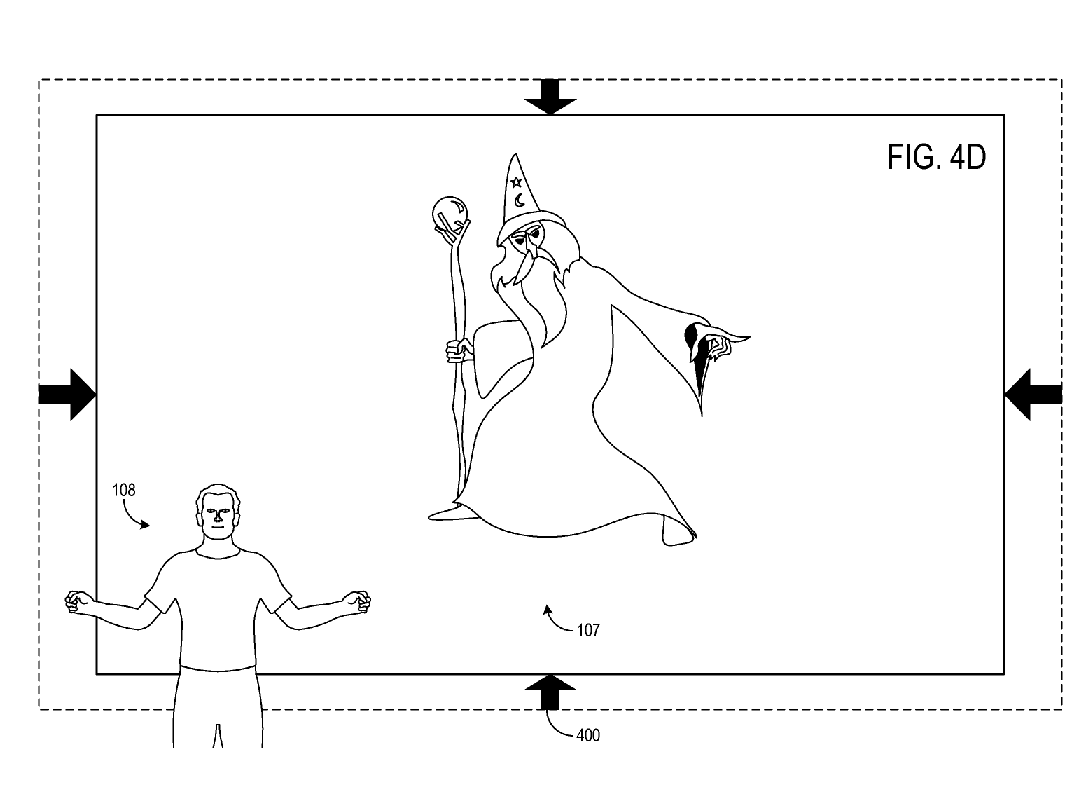

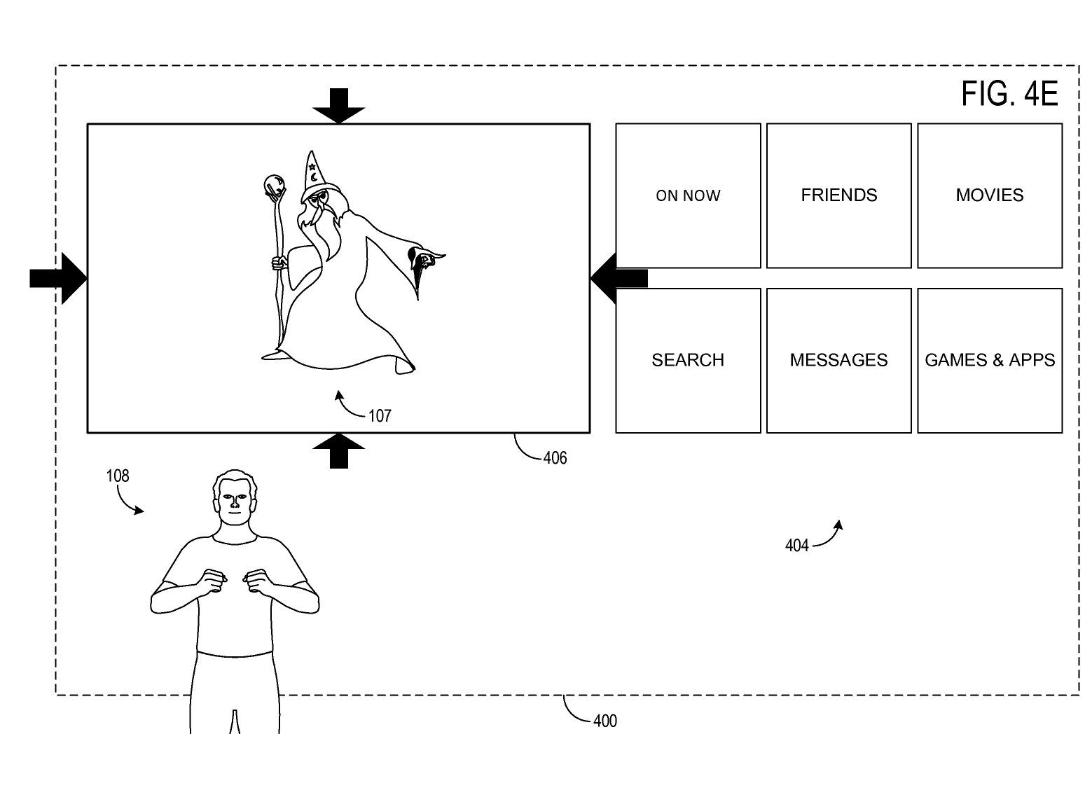

FIGS. 4A-E illustrate an example two hand gesture in the form of an OS pull-in gesture. The output of display device 104 is schematically illustrated by a window 400. As shown in FIG. 4A, user 108 is initially in an at-rest pose with his arms at his sides (shown in dashed lines). At this initial stage of the OS pull-in gesture. At a later stage, user 108 lifts and spreads his arms out to express an intention of addressing the OS with gestural input.

In FIG. 4B, the computing system recognizes that gestural input is intended based on tracking data indicating the position of the arms of user 108 and that the hands of the user are in an open state. In response, hand icons 402 are overlaid over game application 107 to suggest the next step of the gesture, indicating that both hands should be pulled inward in a closed state. Hand icons 402 also indicate that a two hand gesture is anticipated.

As shown in FIG. 4C, user 108 accordingly begins to bring his arms inward with both hands in a closed state. In response, the action to which the gesture maps is previewed in FIG. 4D, which in this example reduces the apparent size of game application 107 in window 400 while bringing in a graphical user interface (GUI) of the OS. Additional visual feedback may be provided when the user changes from an open hand state to a closed hand state to illustrate engagement with window.

In FIG. 4E, user 108 has completed the OS pull-in gesture by fully pulling in both arms with both hands in a closed state. Accordingly, a GUI 404 of the OS is displayed by shrinking the apparent size of game application 107 and placing a reduced window 406 of the game application within the GUI. As shown, GUI 404 includes a plurality of icons which may be engaged (e.g., via gesture input) to enact various functions of the OS—e.g., multimedia playback, content search, etc.

In some embodiments, game application 107 may be caused to resume full occupation of window 400 by reversing the order in which the steps of the OS pull-in gesture are performed. In other embodiments, a separate gesture may be provided to resume full window occupation by an application and exit the OS GUI.

The OS pull-in gesture illustrated by FIGS. 4A-4E is an example of a gesture which may be performed to control aspects of an OS when a running application has focus of the OS, and in some scenarios, occupies an entirety of display output. By using gestures of this type in combination with application-specific input (gestural or otherwise), navigation both within and between applications, and with an OS, may be facilitated. Smooth application and OS control may be further aided by the provision of visual feedback such as hand icons 402. Such visual feedback may help to make gestural interaction a natural, intuitive process by confirming recognition of a gesture, suggesting subsequent steps in the gesture, and previewing action(s) effected by the gesture. In some embodiments, visual feedback may be provided incrementally at each step of the gesture.

The OS pull-in gesture shown in FIGS. 4A-4E also illustrates an example of a symmetric two hand gesture. In particular, the movements and states of the left and right arms and hands of user 108 minor each other about a vertical plane extending throughout the center of the user as the gesture is performed. As such, the OS pull-in gesture exhibits what may be called “minor symmetry” and may be designated a “mirror-symmetric” gesture.

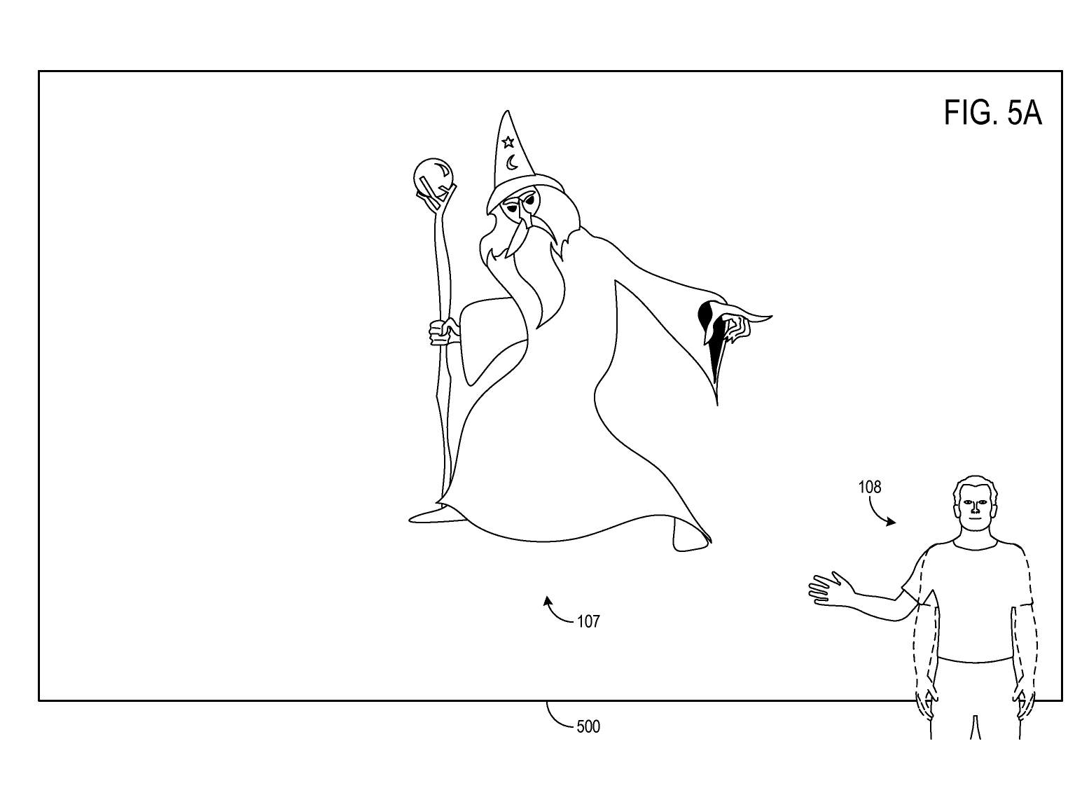

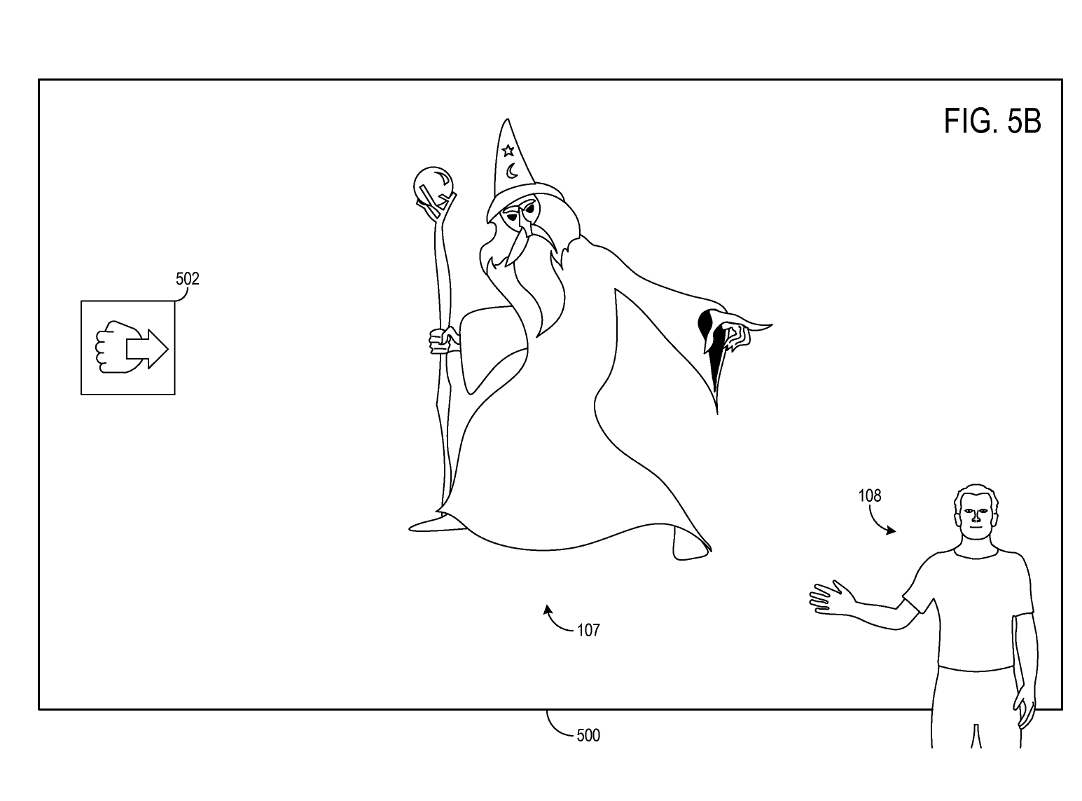

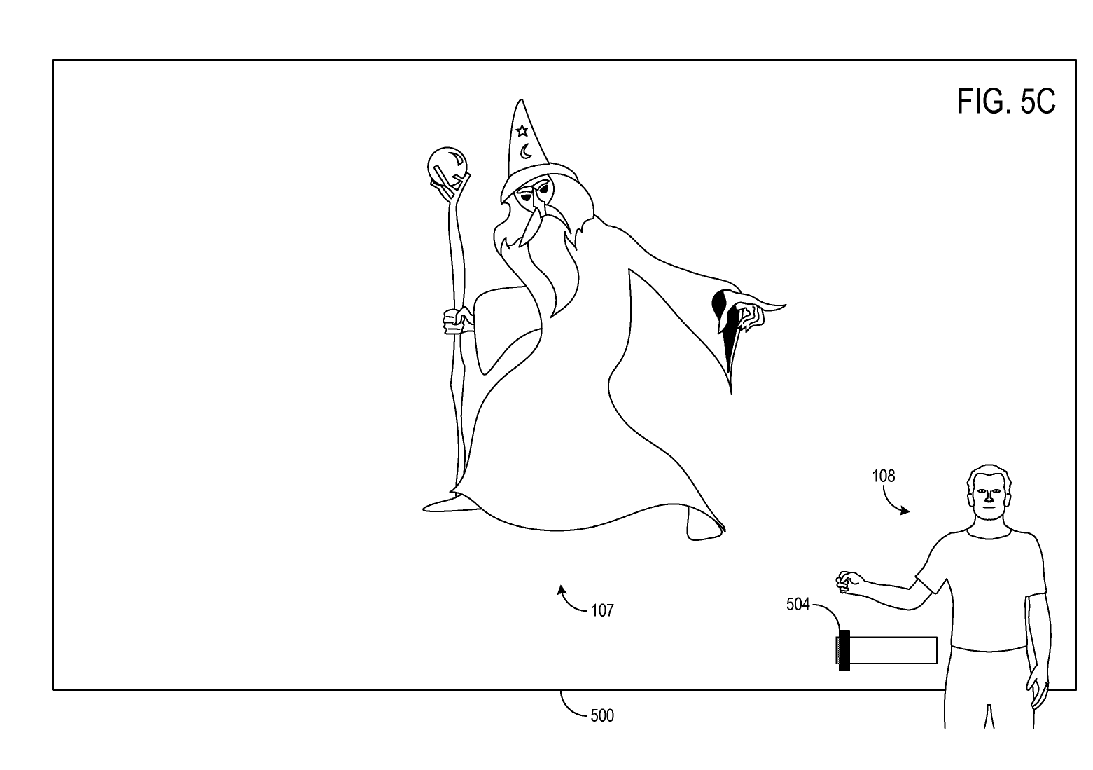

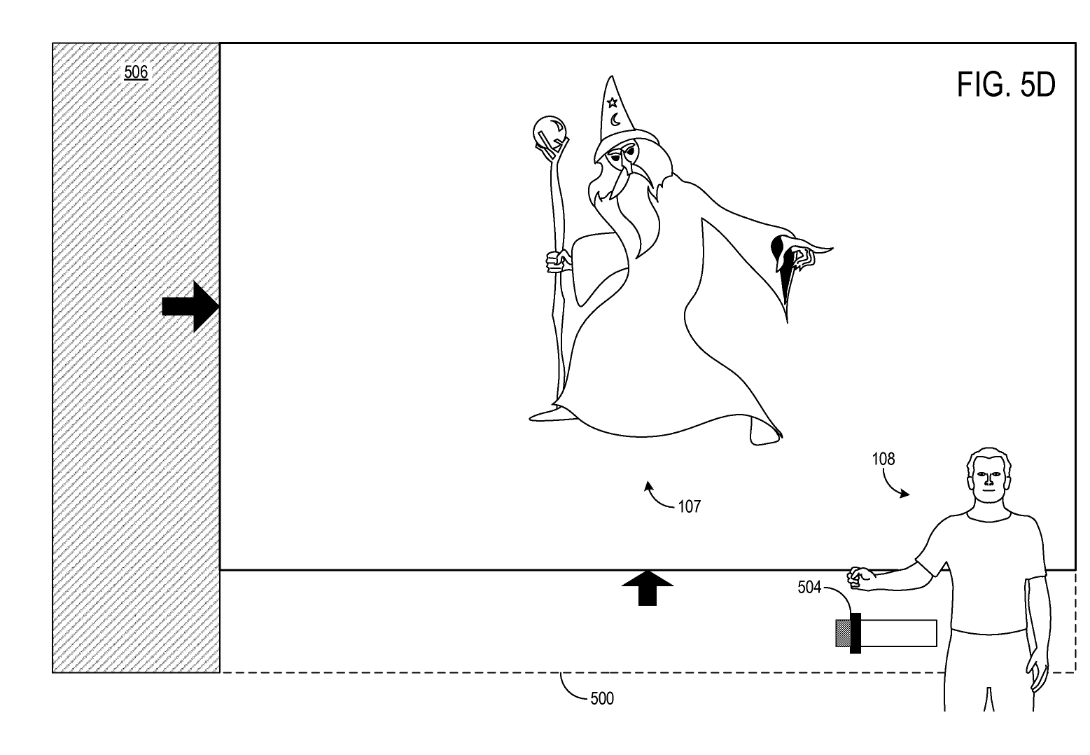

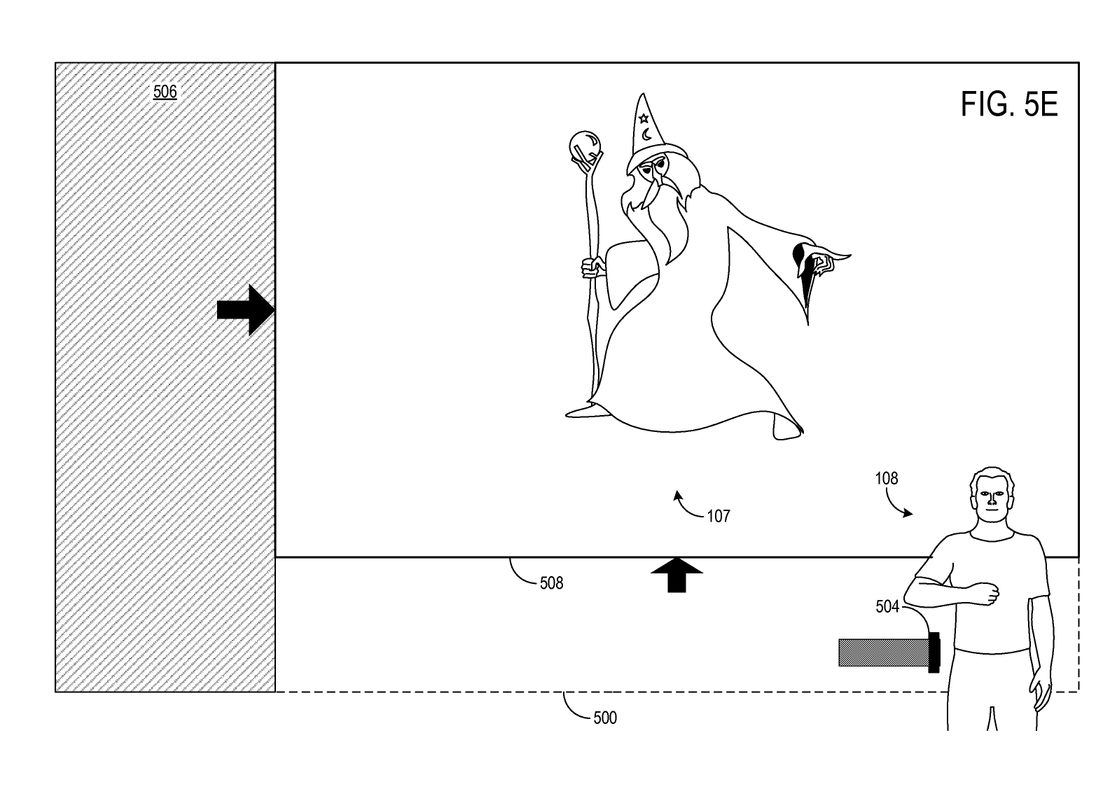

FIGS. 5A-5E illustrate an example one hand gesture which may be performed by user 108 and interpreted by computing system 102 according to method 300. As in FIGS. 4A-4E, the output of display device 104 is schematically illustrated by a window 500, as is the disposition of user 108 at various stages throughout performance and interpretation of the gesture. In this example, the user's left hand may be tracked along with the right hand, as maintaining the left hand at one side while performing a gesture with the right hand may indicate an intent to perform a one hand gesture.

As shown in FIG. 5A, user 108 is initially in an at-rest pose with his arms at his sides (shown in dashed lines). Then, at a subsequent stage, user 108 lifts and spreads out his right arm with the intention of addressing the OS with gestural input.

In FIG. 5B, the computing system recognizes that gestural input is intended based on tracking data indicating the position of the arms of user 108 and that the right hand is in an open state. In response, a hand icon 502 is overlaid over game application 107 to suggest the next step of the gesture, indicating that the right hand should be pulled inward in a closed state. Hand icon 502 also indicates that a one hand gesture is anticipated.

As shown in FIG. 5C, user 108 accordingly begins to bring his right arm inward with the right hand in a closed state. Visual feedback is provided in the form of a spatial progress bar 504 which indicates the progress of user 108 as the application pull-in gesture is performed. Subsequently, the action to which the gesture maps is previewed in FIG. 5D, which in this example reduces the apparent size of game application 107 in window 500 while bringing in a side application 506 from the left side. Spatial progress bar 504 is also updated to reflect user progress in completing the application pull-in gesture.

In FIG. 5E, user 108 has completed the application pull-in gesture by fully pulling in his right arm with the right hand in a closed state. Accordingly, side application 506 is snapped to the left side of window 500 with game application 107 displayed in a reduced window 508 to accommodate the side application, represented in FIG. 5E generically as a grayed-out box. In some embodiments, upon completing the application pull-in gesture and snapping side application 506 to the left side of window 500, input (gestural or otherwise) supplied by user 108 may be exclusively fed to the side application. In other embodiments, the user may indicate an intent regarding the application or OS with which to interact.

As mentioned above, the application pull-in gesture shown in FIGS. 5A-5E illustrates an example of simultaneously tracking two hands to enhance the interpretation of one hand gestures. Since the left hand of user 108 remained in a fixed position while the right hand performed a recognized one hand gesture, it may be confidently assumed that the recognized one hand gesture was intended by the user. More generally, a lack of motion in a hand opposite a hand performing a known one hand gesture may confirm intent to perform the known one hand gesture. While both hands of a user may be persistently tracked in this example and data regarding both hands may be analyzed to identify the gesture, the user may perceive gestural input as being performed by one hand.

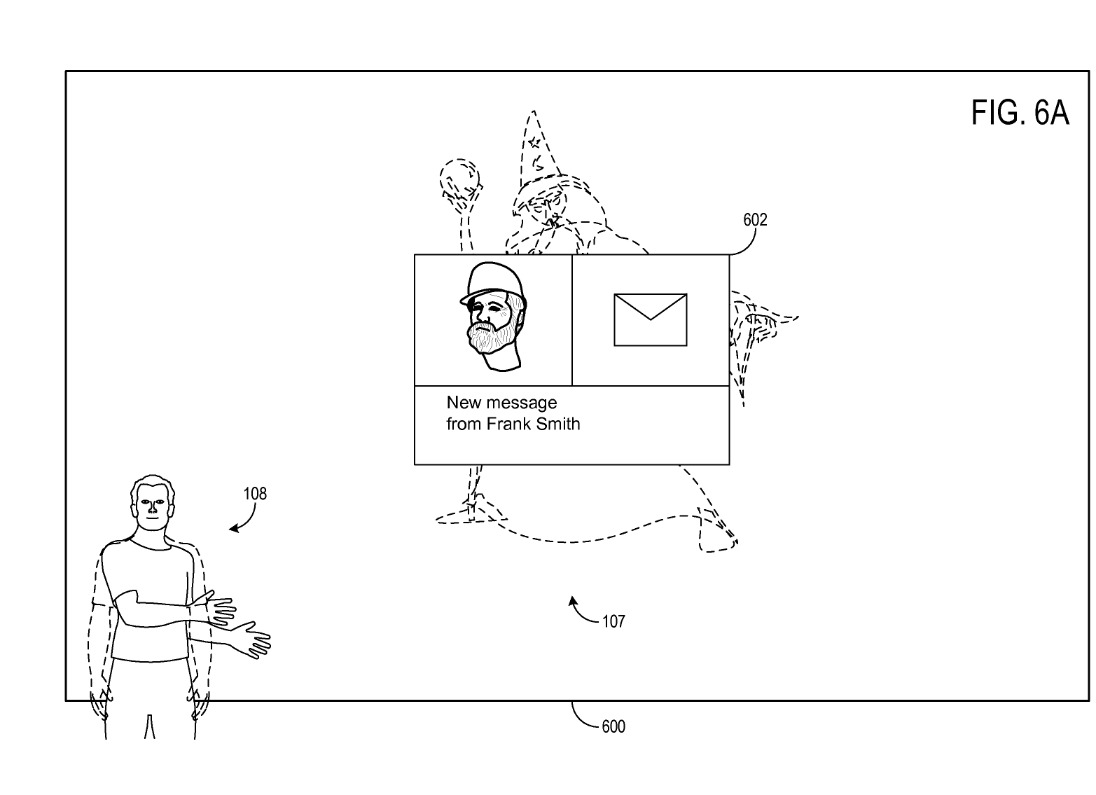

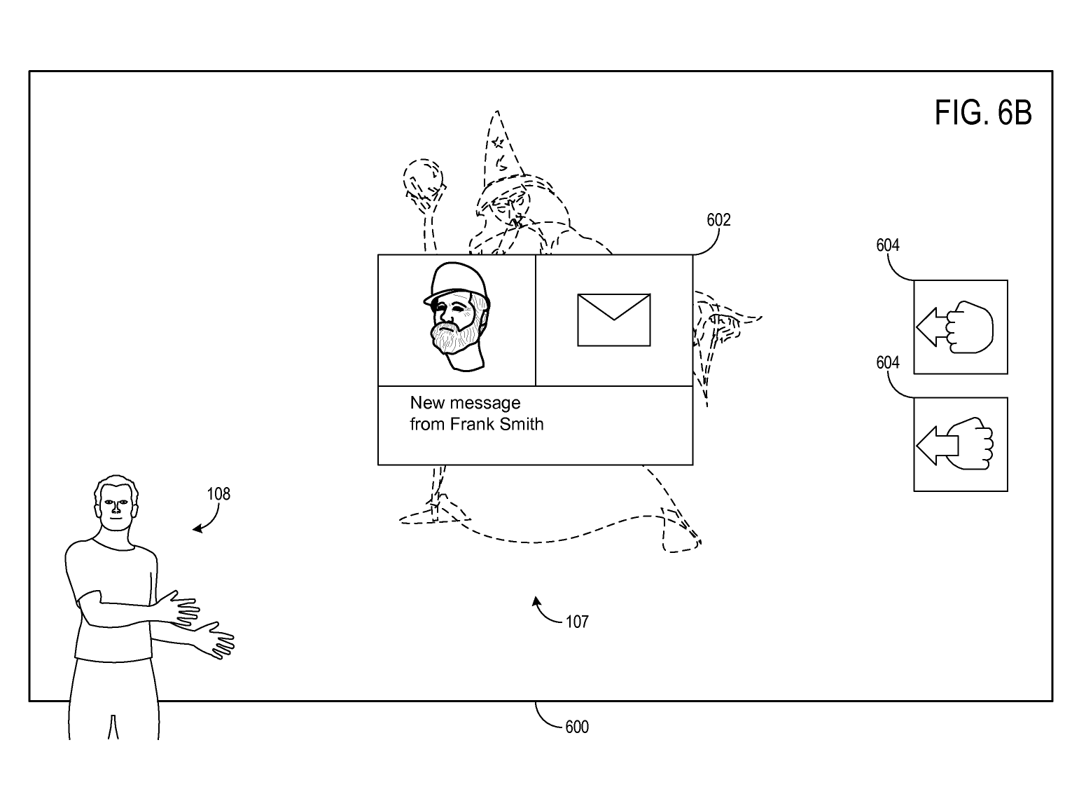

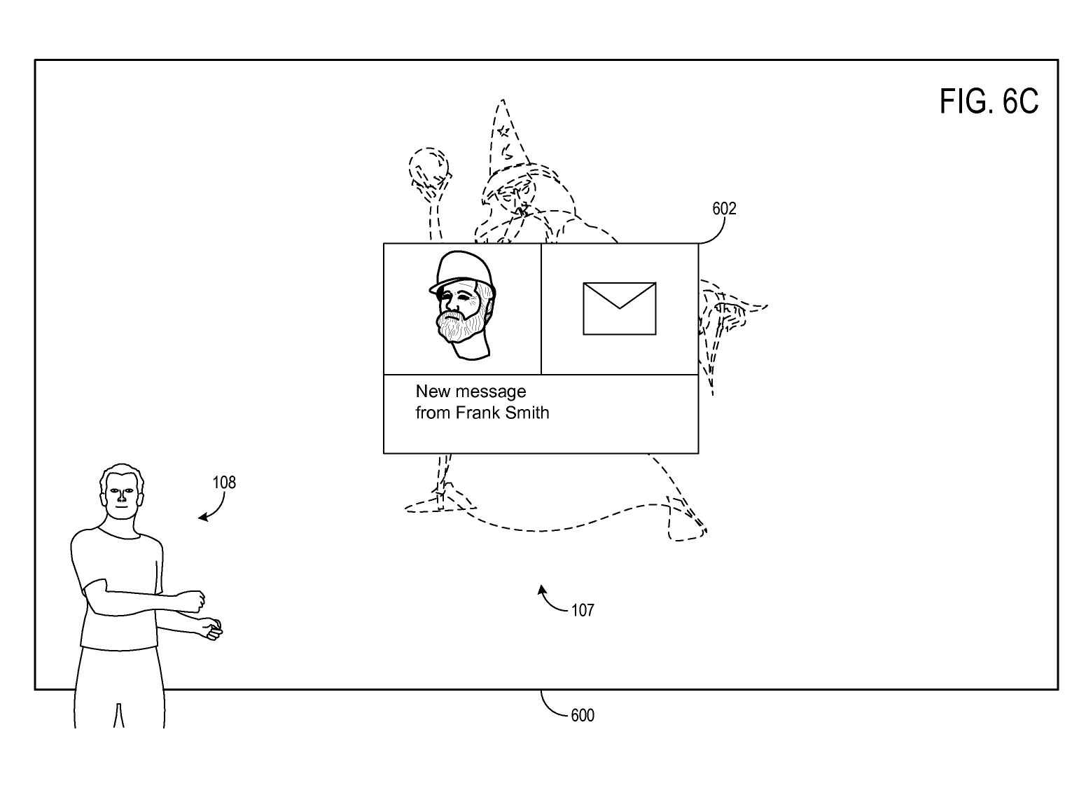

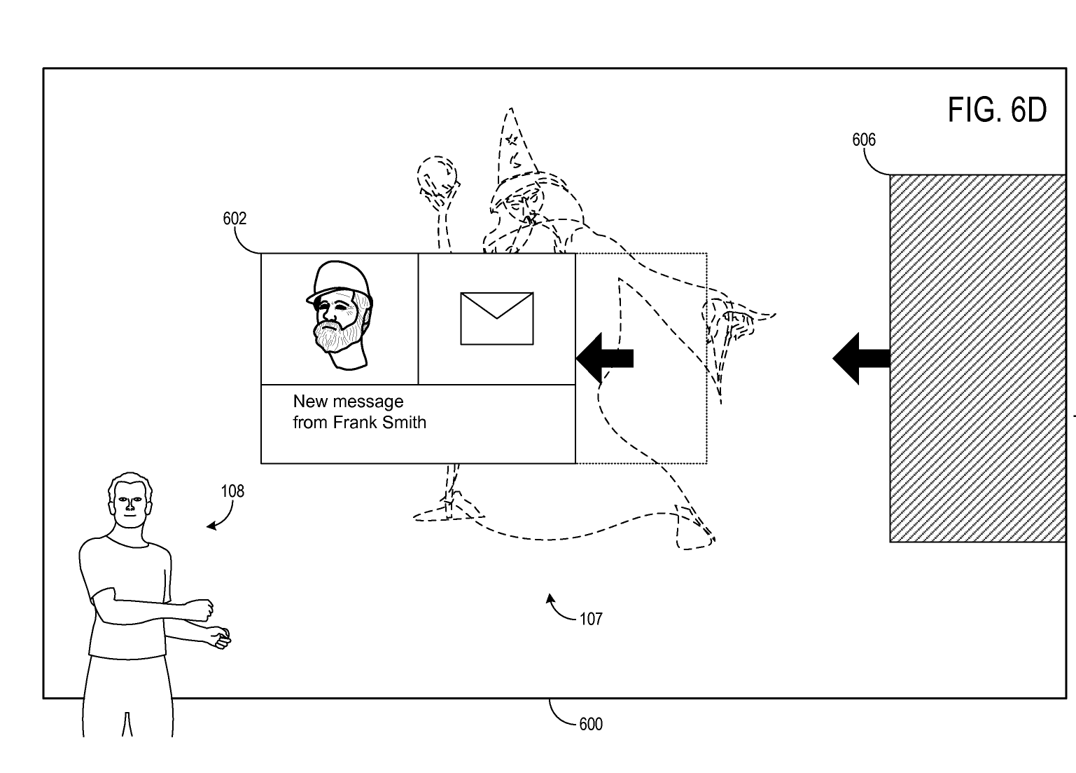

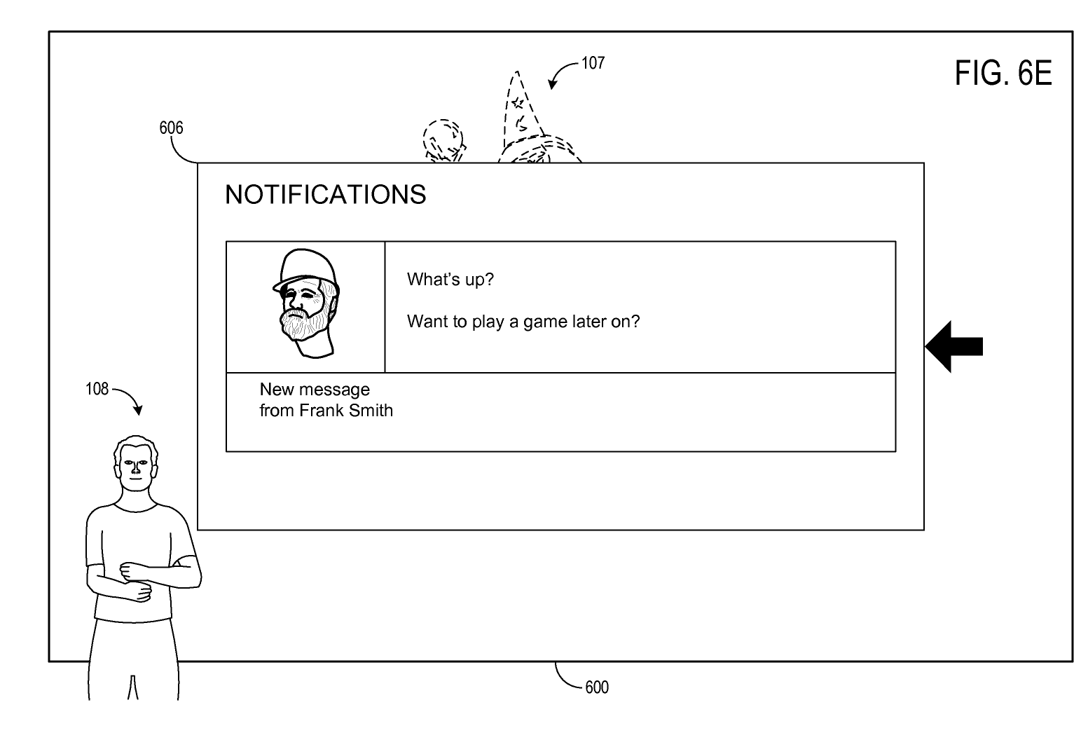

FIGS. 6A-6E illustrate another example two hand gesture shown as invoking an OS overlay. The output of display device 104 is schematically illustrated by a window 600, as is the disposition of user 108 at various stages throughout the performance and interpretation of the gesture.

As shown in FIG. 6A, user 108 is initially in an at-rest pose with his arms at his sides (shown in dashed lines). At this initial state of the OS overlay gesture, user 108 does not intend on gestural interaction with the OS but rather game application 107, represented in FIG. 6A by dashed lines. Thereafter, an OS notification preview 602 is overlaid on top of game application 107, indicating that user 108 has received a message from an acquaintance. Accordingly, user 108 positions his arms outwardly toward his left side with the intention of addressing the OS and notification preview 602.

In FIG. 6B, the computing system recognizes that gestural input is intended based on tracking data indicating the position of the arms of user 108 and that the hands of the user are in an open state. In response, hand icons 604 are overlaid over game application 107 to suggest the next step of the gesture, indicating that both hands should be pulled inward toward the center of user 108 in a closed state.

In FIG. 6C, user 108 initiates the OS overlay gesture by putting both hands in a closed state. In response, notification preview 602 is translated toward the left side of the figure as a notification menu 606 comes into view from the right side of the figure in FIG. 6D.

In FIG. 6E, user 108 has completed the OS overlay gesture by fully pulling in both arms toward his center with both hands in a closed state. Accordingly, notification menu 606 replaces notification preview 602 which is no longer displayed. Notification menu 606 may, for example, display the contents of the message indicated by notification preview 602, in addition to other messages and information.

The OS overlay gesture shown in FIGS. 6A-6E illustrates another type of symmetric two hand gesture. While displaced from each other, the left and right arms and hands of user 108 undergo the same movements in the same direction. As such, the OS overlay gesture exhibits what may be called “translational symmetry” and may be designated a “translationally-symmetric” gesture.

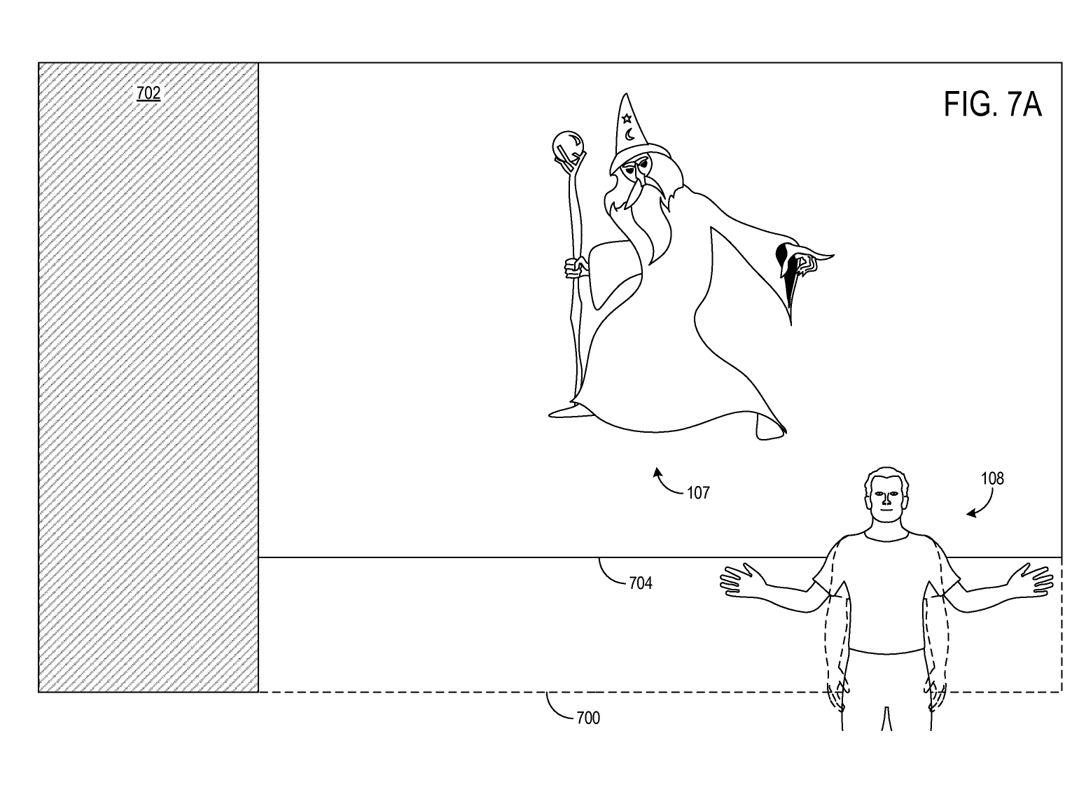

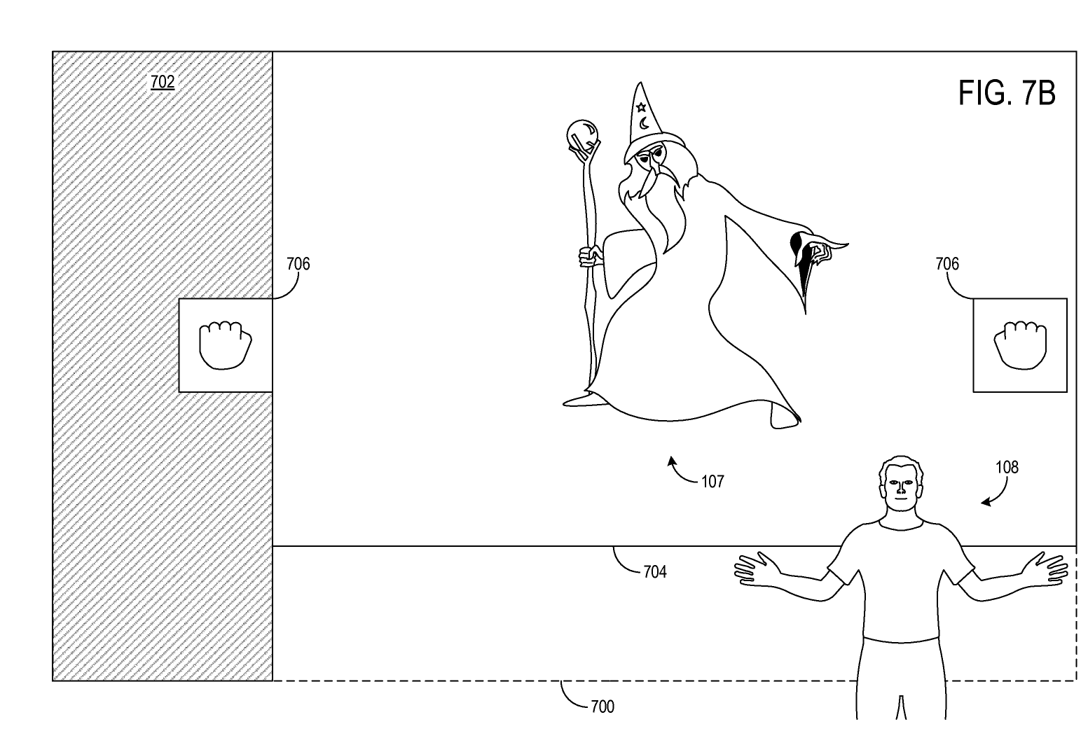

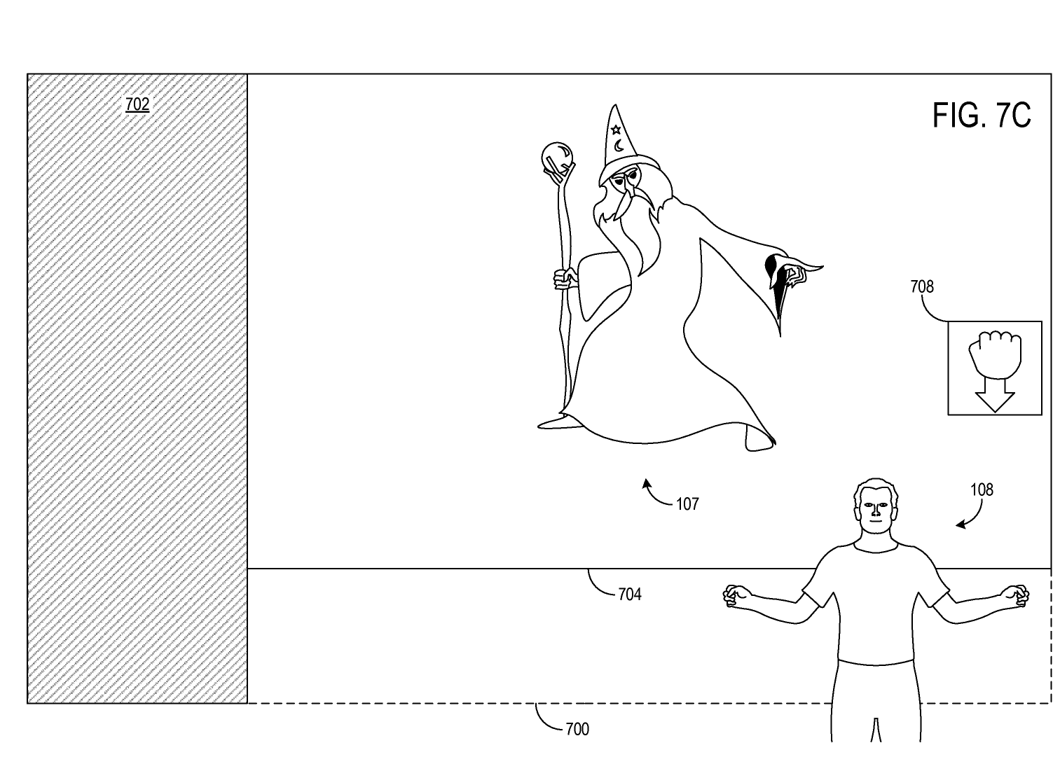

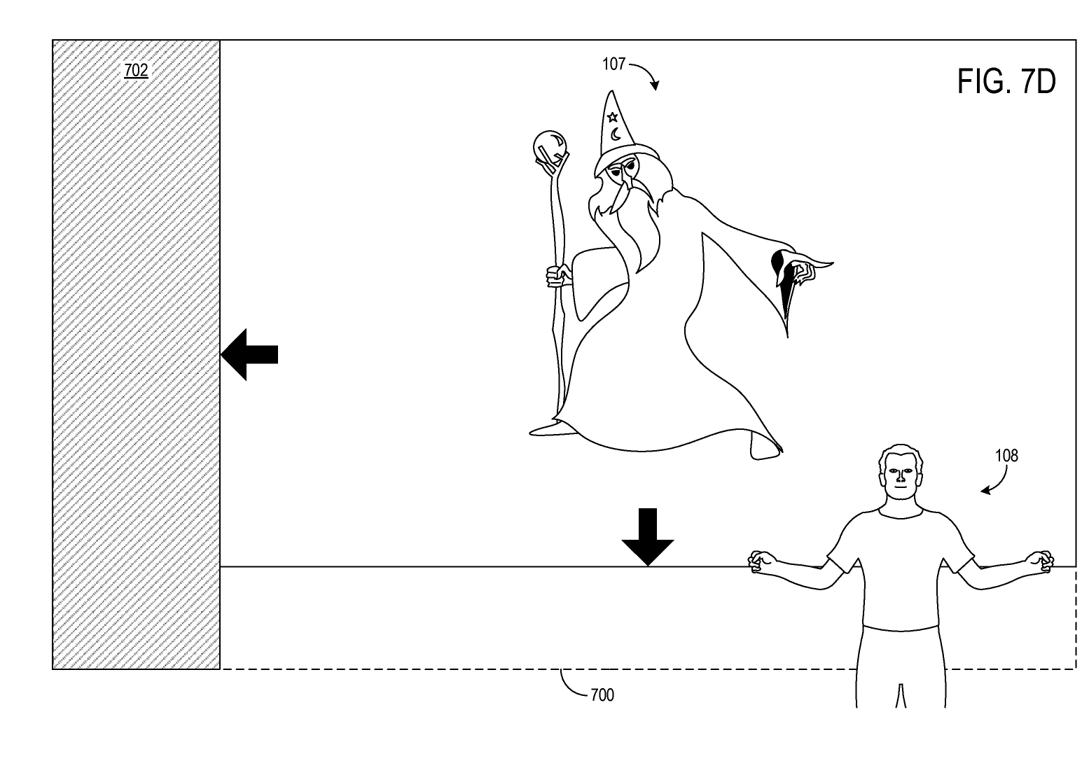

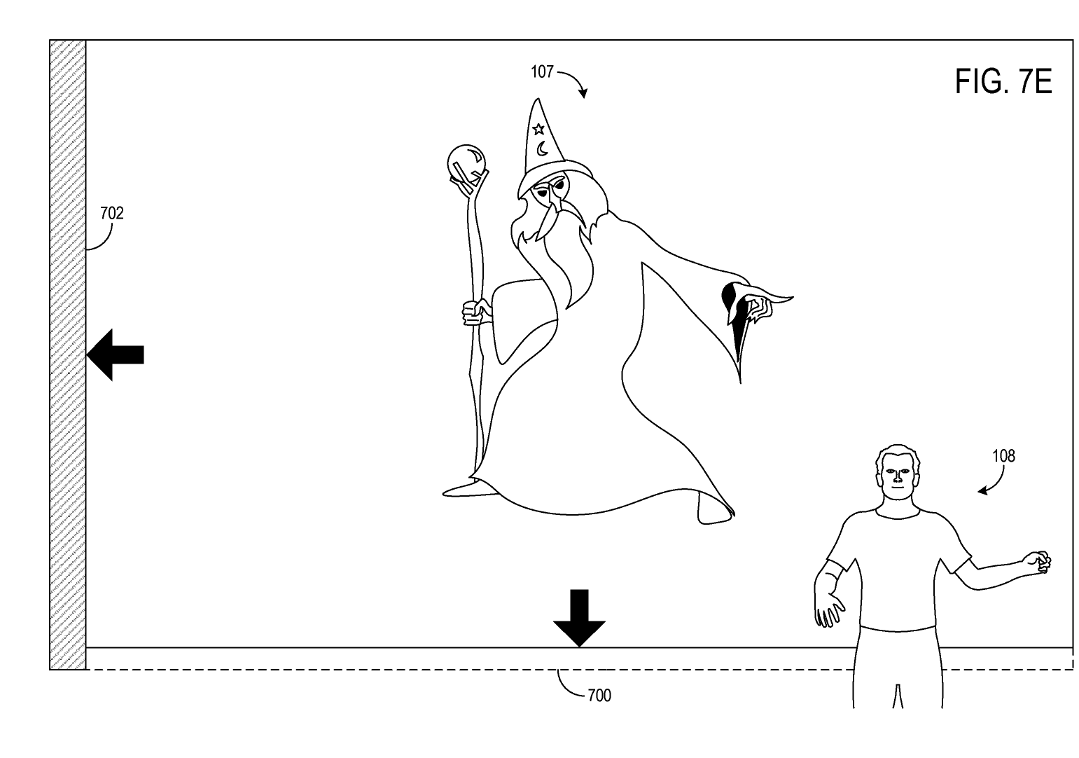

FIGS. 7A-7E illustrate an example application pull-down gesture which may be performed by user 108 and interpreted by computing system 102 according to method 300. The output of display device 104 is schematically illustrated by a window 700, as is the disposition of user 108 at various stages throughout performance and interpretation of the OS pull-down gesture.

As shown in FIG. 7A, user 108 is initially in an at-rest pose with his arms at his sides (shown in dashed lines). Heretofore user 108 has been interacting with a side application 702 snapped to the left side of window 700, for example via the application pull-in gesture shown in FIGS. 7A-7E. During this interaction, game application 107 is displayed in a reduced window 704. However, user 108 wishes to return interaction to game application 107 and cease display of side application 702. Accordingly, user 108 lifts and spreads his arms out to initiate gestural interaction.

In FIG. 7B, the computing system recognizes that gestural input is intended based on tracking data indicating the position of the arms of user 108 and that the hands of the user are in an open state. In response, hand icons 706 are overlaid over game application 107 to suggest the next step of the gesture, indicating that both hands should be disposed in a closed state.

In FIG. 7C, user 108 accordingly places both hands in a closed state. In response, a new hand icon 708 is displayed, suggesting that the right hand of user 108 be pulled downward while maintaining the hand in a closed state. As shown in FIG. 7D, the action to which the gesture maps is previewed, expanding the apparent size of game application 107 while moving side application 702 out of view in a leftward direction.

In FIG. 7E, user 108 is nearing completion of the application pull-down gesture by pulling the right arm downwardly while maintaining both hands in a closed state. Accordingly, side application 702 is ceasing to be displayed while game application 107 resumes full occupation of window 700.

The application pull-down gesture shown in FIGS. 7A-7E illustrates an example of an asymmetric two hand gesture. While both arms are initially spread apart in a mirror-symmetric fashion, once both hands are closed it is only the right arm which is pulled downward to effect application action. As such, the application pull-down gesture may be considered to comprise a symmetric gesture (mirror-symmetric arm spread) temporally separated by an asymmetric gesture (right hand pull down while maintaining the left hand in a static, closed state). In some embodiments, interpretation of this gesture, in addition to other asymmetric two hand gestures, may utilize first hand tracking data and second hand tracking data which does not temporally overlap. For example, first hand tracking data indicating that the right hand of user 108 is pulling down may be temporally separated from second hand tracking data previously indicating that the left hand was extended outwardly.

While the example gestures shown and described above generally correspond to hand gestures performed in three-dimensional space, other types of gestures are within the scope of this disclosure such. For example, finger gestures in which gestures are performed by a single finger may be used to control aspects of an application and OS. Hand and/or finger gestures typically performed on tactile touch sensors (e.g., as found in mobile electronic devices) are also contemplated.

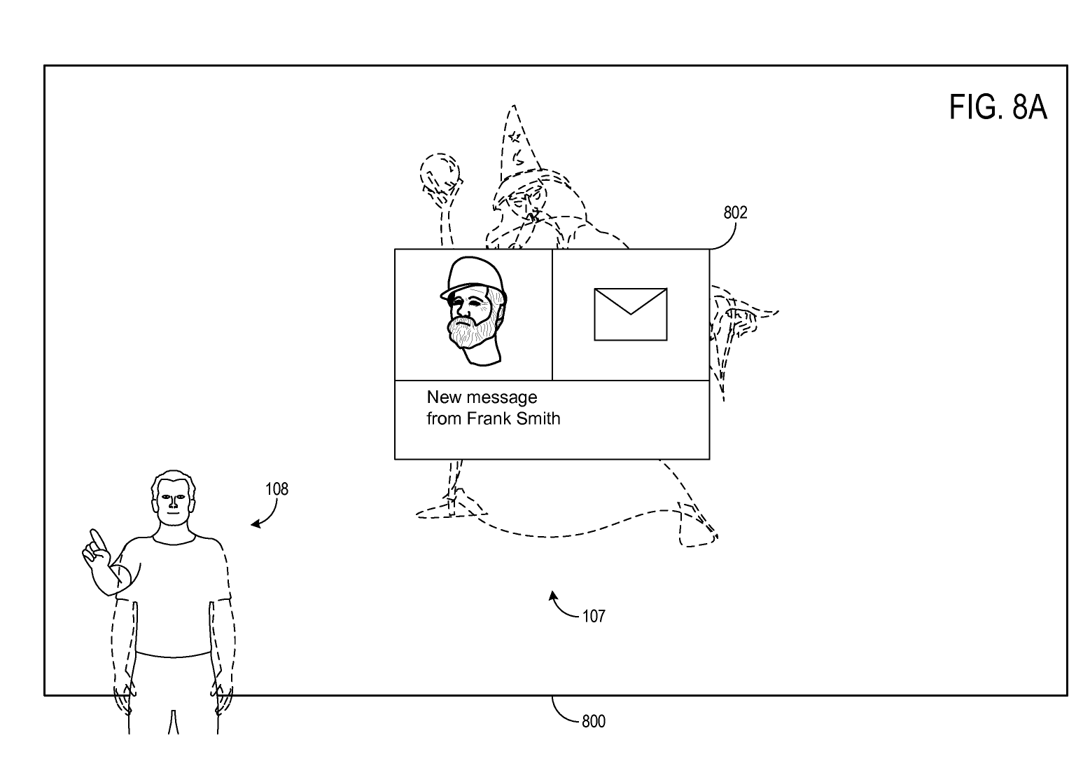

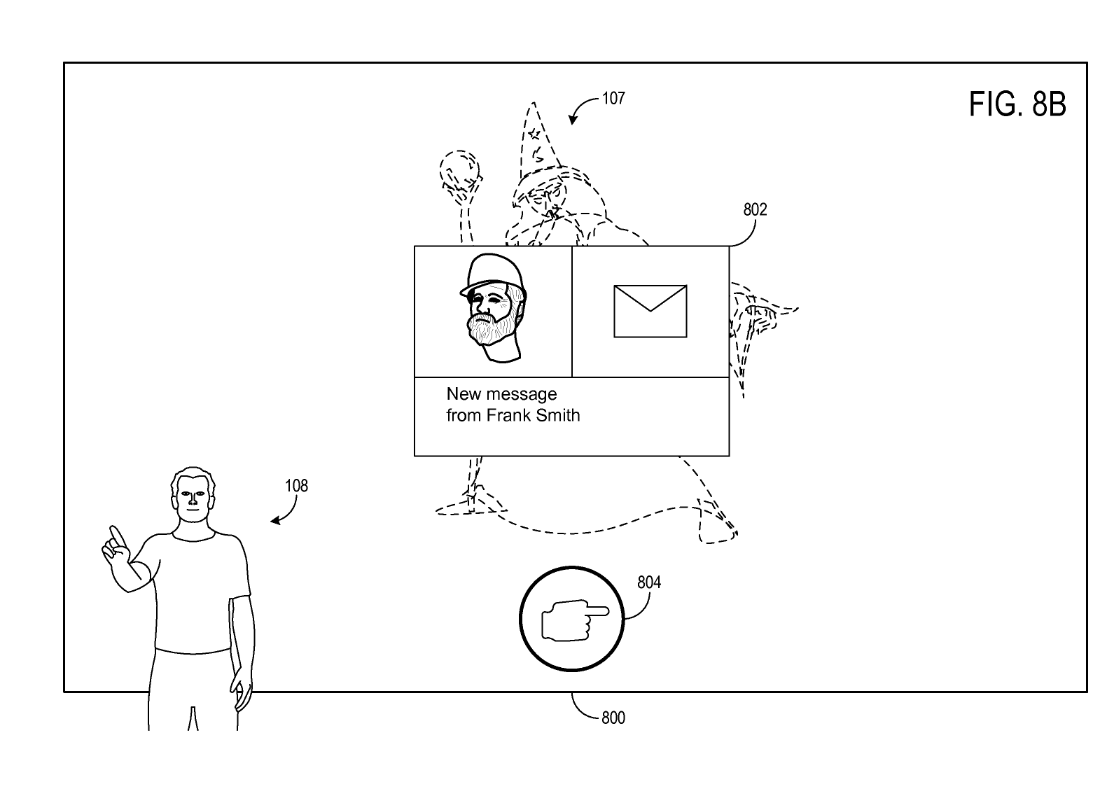

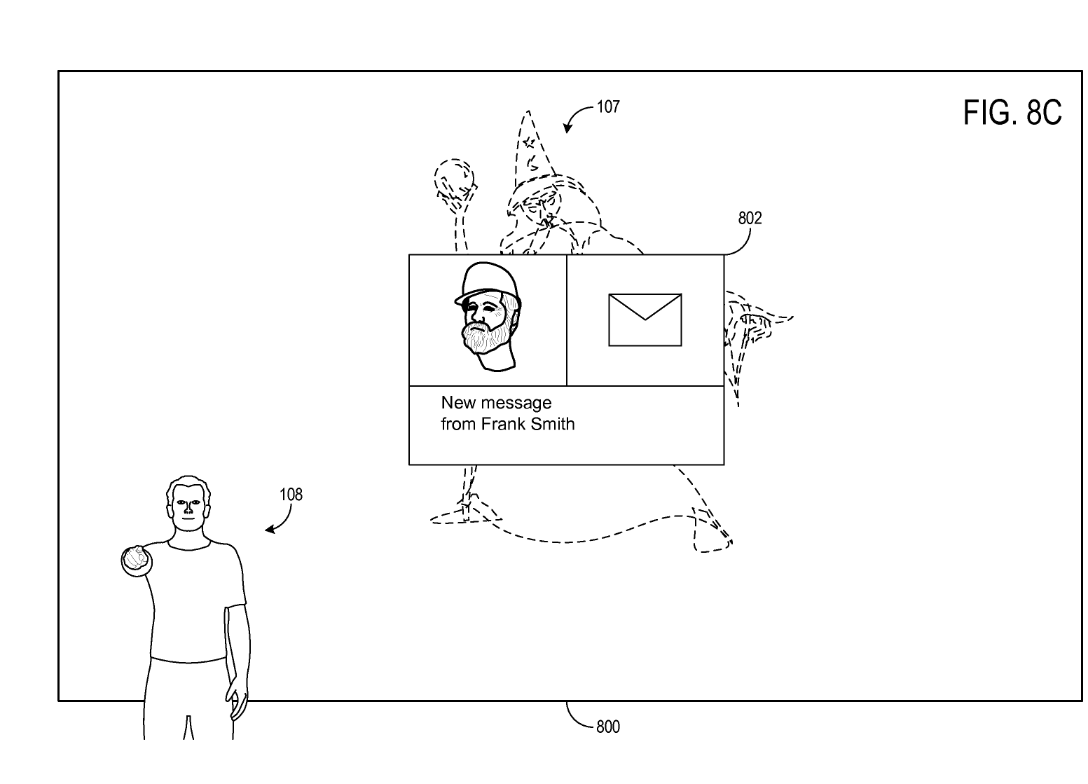

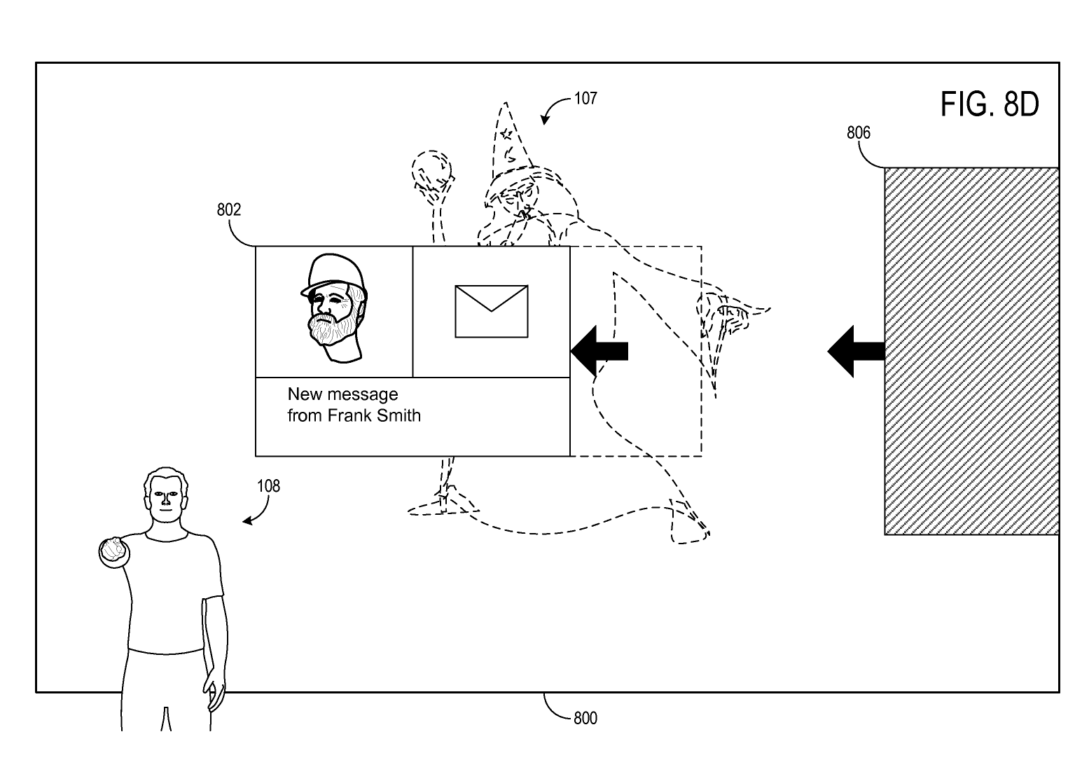

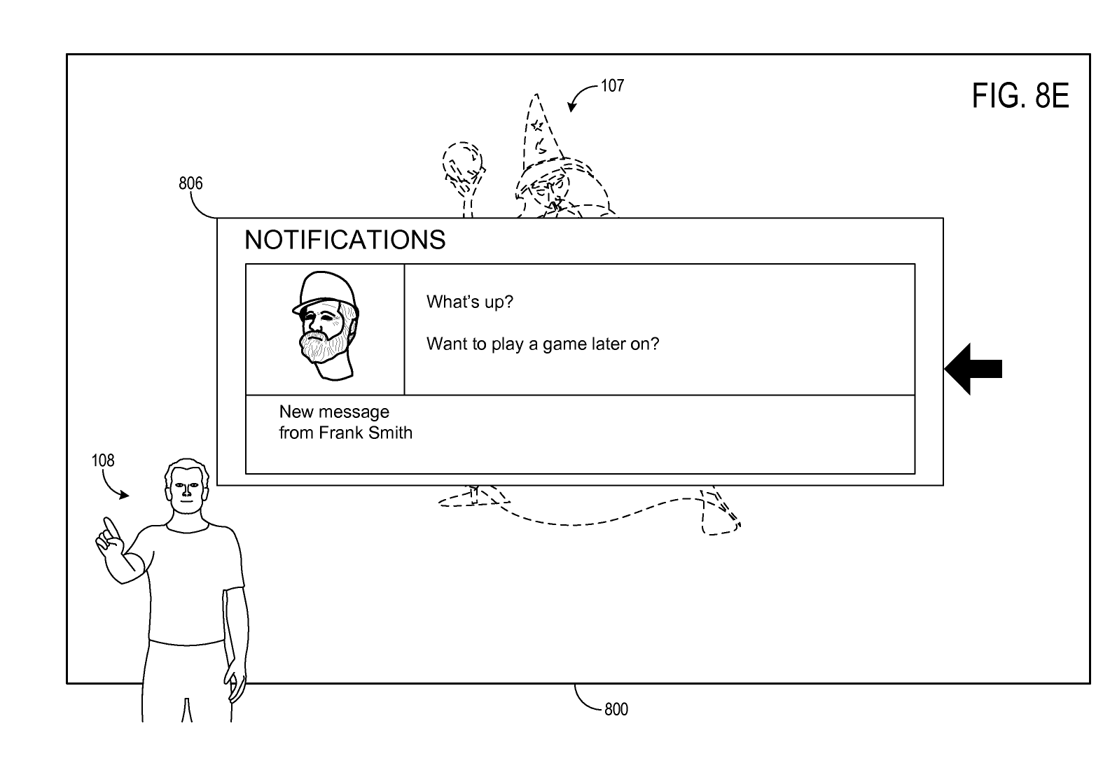

FIGS. 8A-8E illustrate an example finger gesture which may be performed by user 108 and interpreted by computing system 102 according to method 300. The output of display device 104 is schematically illustrated by a window 800, as is the disposition of user 108 at various stages throughout performance and interpretation of the finger gesture.

As shown in FIG. 8A, user 108 is initially in an at-rest pose with his arms at his sides (shown in dashed lines). Next, an OS notification preview 802 is overlaid on top of game application 107, indicating that user 108 has received a message from an acquaintance. Accordingly, user 108 places his right index finger along a forward direction in a pointing posture with the intention of addressing the OS and notification preview 802.

In FIG. 8B, the computing system recognizes that gestural input is intended based on tracking data indicating the position and posture of the hands and fingers of user 108. The tracking data may comprise, for example, first and second hand posture data indicating the posture of the left and right hands, respectively. In response, a finger icon 804 is overlaid over game application 107 to suggest the next step of the gesture, indicating that the right index finger should be pointed directly forward toward the sensor system. Finger icon 804 also indicates that a finger gesture is anticipated.

In FIG. 8C, user 108 accordingly points his right index finger directly toward the sensor system to initiate the gesture. In response, notification preview 802 is translated toward the left side of the figure as a notification menu 806 comes into view from the right side of the figure in FIG. 8D.

In FIG. 8E, user 108 has completed the OS overlay gesture by maintaining his right index finger in the forward point posture for at least a threshold duration. Accordingly, notification menu 806 replaces notification preview 802 which is no longer displayed. Notification menu 806 may, for example, display the contents of the message indicated by notification preview 802, in addition to other messages and information.

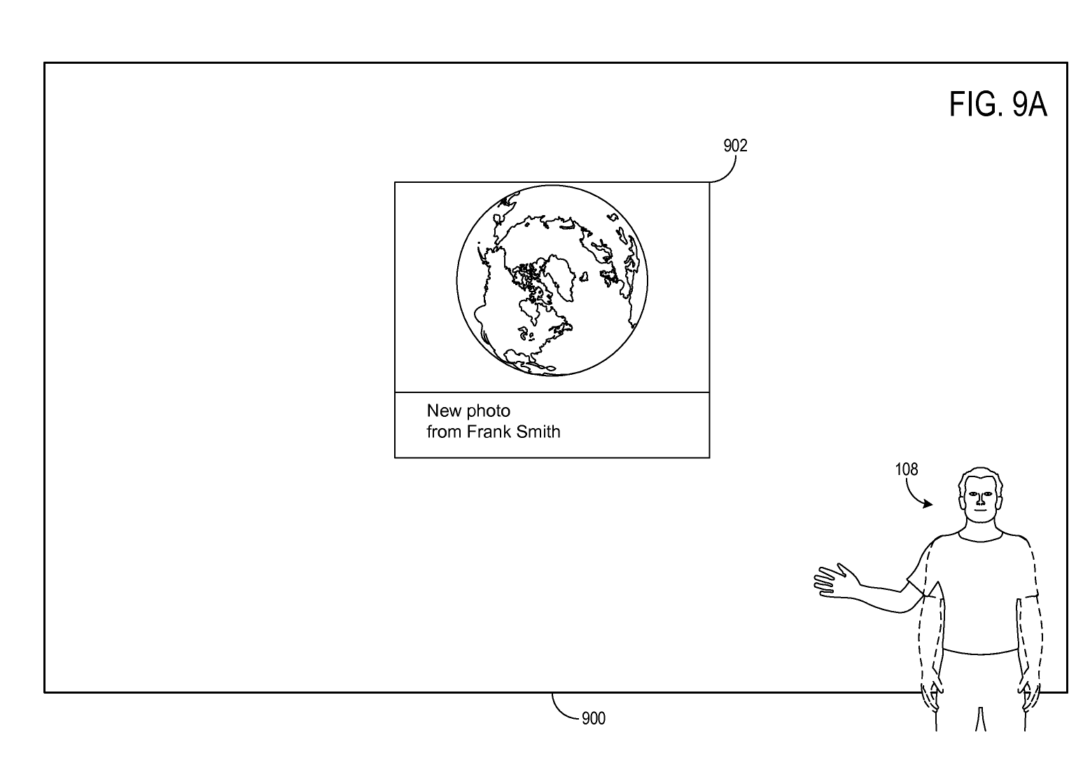

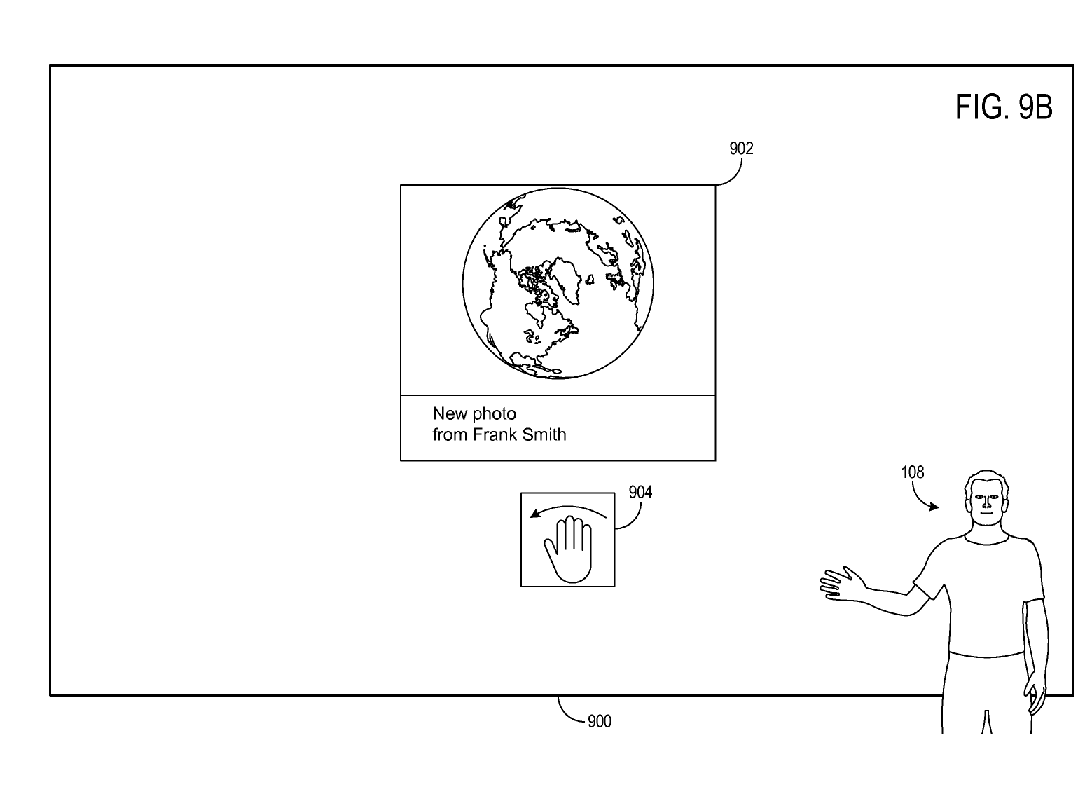

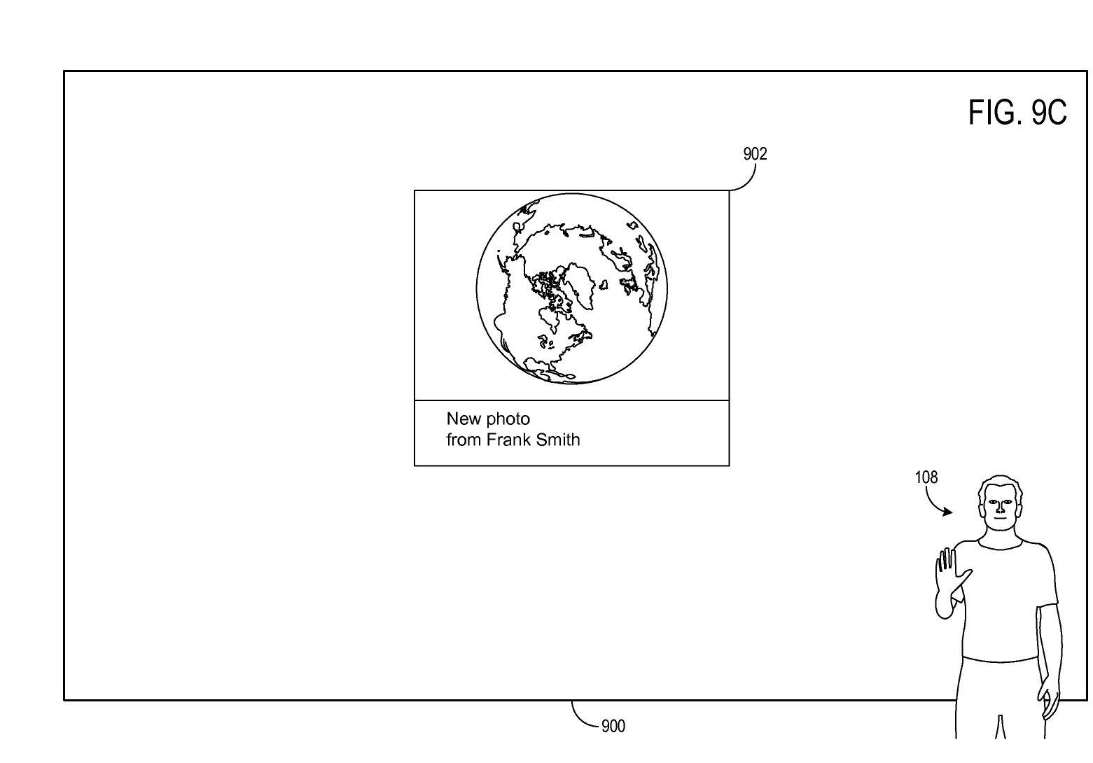

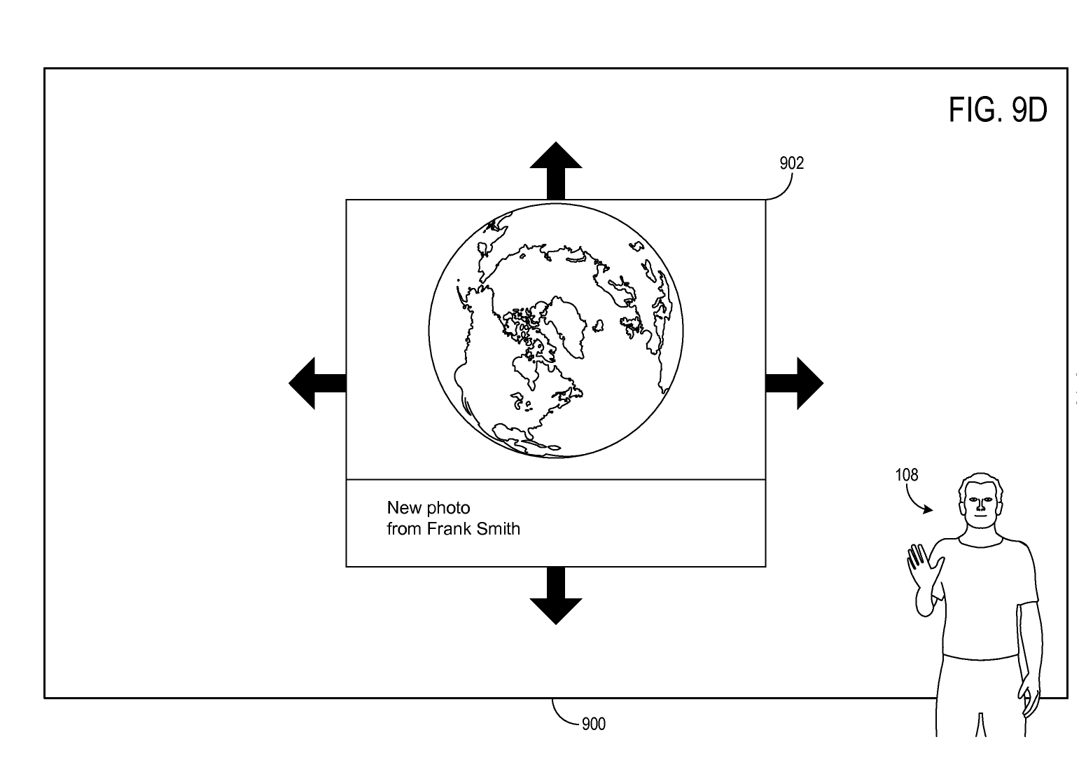

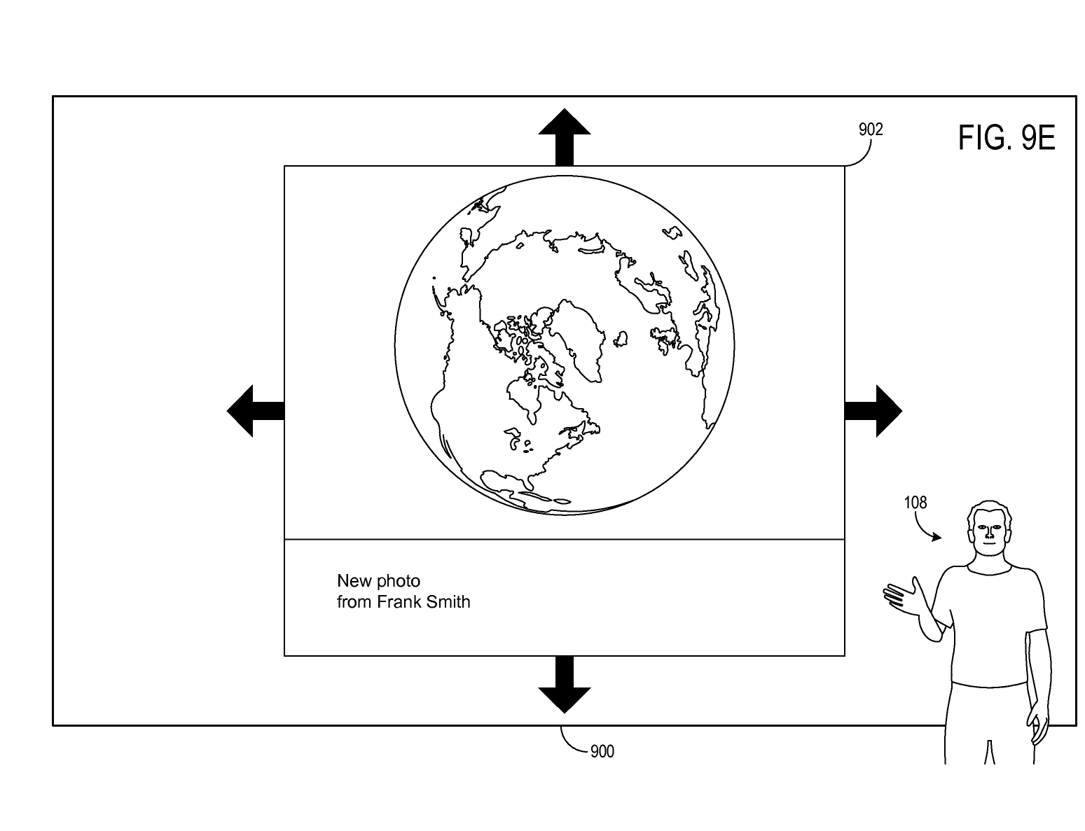

FIGS. 9A-9E illustrate an example OS zoom gesture which may be performed by user 108 and interpreted by computing system 102 according to method 300. The output of display device 104 is schematically illustrated by a window 900, as is the disposition of user 108 at various stages throughout performance and interpretation of the OS zoom gesture.

As shown in FIG. 9A, user 108 is initially in an at-rest pose with his arms at his sides (shown in dashed lines). Thereafter, an OS image notification 902 is overlaid on top of game application 107, indicating that user 108 has received an image from an acquaintance. Accordingly, user 108 positions his right arm outwardly with the intention of addressing the OS and image notification 902.

In FIG. 9B, the computing system recognizes that gestural input is intended based on tracking data indicating the position of the arms of user 108 and that the hands of the user are in an open state. In response, a hand icon 904 are overlaid over game application 107 to suggest the next step of the gesture, indicating that the right hand should be rotated in a clockwise direction (from the perspective of user 108), starting from a vertical, upward position.

In FIG. 9C, user 108 initiates the OS zoom gesture by placing the right hand in the vertical, upward position. In response, image notification 902 is expanded by an amount proportional to the degree of rotation of the right hand of user 108 in FIG. 9D.

In FIG. 9E, user 108 has completed the OS zoom gesture by fully rotating (e.g., 90)° the right hand clockwise. Accordingly, image notification 902 is fully expanded, occupying substantially the entirety of window 900.

It will be appreciated that the gestures illustrated in FIGS. 4A-9E are provided as examples and are not intended to be limiting in any way, and that any other suitable gestures may be defined by positions, postures, paths, etc. of two hands. In some instances, a gesture may be defined to reduce a difficulty of learning the gesture, facilitate its detection by a sensor system, and correspond closely to a user—expected outcome—e.g., a gesture operable to translate displayed objects may be defined by hand translation. Further, the times at which visual feedback is provided and the action effected may deviate from those depicted. It should be understood that the approaches shown and described herein can be used to assemble a potentially large dictionary of gestures and effected actions, which may control one or more aspects of an application and/or operating system and facilitate multitasking. Such gestures may include hand gestures, finger gestures, and/or gestures typically intended for tactile touch sensors. Moreover, these gestures may exhibit mirror symmetry, translational symmetry, asymmetry, and/or temporally-separated symmetry and asymmetry.

While the effects of gestural interaction are conveyed by changes in output from display device 104 in environment 100, it will be appreciated that the approaches described herein are also applicable to environments which lack a display device. In this example, interpreted gestural input may be conveyed by means other than a display device, and in some scenarios, used to physically control an apparatus. As non-limiting examples, gestural input may be tracked and interpreted to open and close doors, control the position of end effectors of robotic arms, etc.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 10.

Logic subsystem 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 1004 includes one or more physical devices configured to hold instructions executable by the logic machine to implement the methods and processes described herein. When such methods and processes are implemented, the state of storage subsystem 1004 may be transformed—e.g., to hold different data.

Storage subsystem 1004 may include removable and/or built-in devices. Storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1004 may include volatile, nonvolatile, dynamic, static, read/write, read-only, random-access, sequential-access, location-addressable, file-addressable, and/or content-addressable devices.

It will be appreciated that storage subsystem 1004 includes one or more physical devices and excludes propagating signals per se. However, aspects of the instructions described herein alternatively may be propagated by a communication medium (e.g., an electromagnetic signal, an optical signal, etc.), as opposed to being stored on a physical device.

Aspects of logic subsystem 1002 and storage subsystem 1004 may be integrated together into one or more hardware-logic components. Such hardware-logic components may include field-programmable gate arrays (FPGAs), program- and application-specific integrated circuits (PASIC / ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic subsystem 1002 executing instructions held by storage subsystem 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1006 may be used to present a visual representation of data held by storage subsystem 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic subsystem 1002 and/or storage subsystem 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

It will be understood that the configurations and/or approaches described herein are example in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method of receiving simultaneous two hand user input, the method comprising:
receiving first hand tracking data regarding a first hand of a user and second hand tracking data regarding a second hand of the user from a sensor system, the first hand tracking data and the second hand tracking data being temporally overlapping;
detecting a gesture based on the first hand tracking data and the second hand tracking data; and
controlling one or more aspects of the computing device based on the gesture detected.

2. The method of claim 1, wherein the first hand tracking data and the second hand tracking data respectively include first hand position data and second hand position data.

3. The method of claim 1, wherein the first hand tracking data and the second hand tracking data respectively include first hand motion data and second hand motion data.

4. The method of claim 1, wherein the first hand tracking data and the second hand tracking data respectively include first hand state data and second hand state data.

5. The method of claim 4, wherein the first hand state data and the second hand state data each corresponds to one of an open hand state and a closed hand state.

6. The method of claim 1, wherein detecting the gesture based on the first hand tracking data and the second hand tracking data includes identifying a one hand gesture based on the first hand tracking data and the second hand tracking data.

7. The method of claim 1, wherein detecting the gesture comprises identifying a two hand gesture.

8. The method of claim 1, wherein the one or more aspects include an application and an operating system.

9. The method of claim 1, wherein the first hand tracking data includes one or more of first hand position data and first hand motion data; and
wherein the second hand tracking data includes second hand posture data.

10. The method of claim 1, further comprising detecting the gesture based on at least a portion of the first hand tracking data and the second hand tracking data which does not temporally overlap.

11. The method of claim 1, wherein the gesture includes one or more stages, the method further comprising providing feedback to the user after each of the one or more stages.

12. The method of claim 1, wherein the feedback includes one or more of an indication of a correctness of the gesture detected, a preview of an action to which the gesture maps, a suggestion of a subsequent gesture, an indication of whether the gesture is a one hand gesture or a two hand gesture, a spatial progress bar, and an indication of whether the gesture maps to an operating system action or an application action.

13. A computing system, comprising:
a logic subsystem; and
a storage subsystem holding instructions executable by the logic subsystem to:
receive first hand tracking data regarding a first hand of a user and second hand tracking data regarding a second hand of the user from a sensor system, the first hand tracking data and the second hand tracking data being temporally overlapping;
determine a first state of the first hand and a second state of the second hand of the user based on the first hand tracking data and the second hand tracking data;
interpret a gesture based on the first state of the first hand and the second state of the second hand; and
adjust one or more aspects of the computing system based on the gesture interpreted.

14. The computing system of claim 13, wherein the first state and the second state correspond respectively to a first posture of the first hand and a second posture of the second hand.

15. The computing system of claim 13, wherein the first state and the second state correspond to one of an open hand state and a closed hand state.

16. The computing system of claim 13, wherein the gesture corresponds to one of a hand gesture, a finger gesture, and a touch gesture intended for a tactile sensor.

17. The computing system of claim 13, further comprising, if the gesture is interpreted as both a one hand gesture and a two hand gesture, preferentially selecting the two hand gesture.

18. The computing system of claim 13, wherein the gesture is a two hand gesture corresponding to one of a symmetric gesture, an asymmetric gesture, and a temporally-separated symmetric-asymmetric gesture.

19. The method of claim 13, wherein the sensor system comprises a depth camera.

20. On a computing device, a method of receiving simultaneous two hand user input, the method comprising:
receiving first hand tracking data regarding a first hand of a user and second hand tracking data regarding a second hand of the user from a sensor system, the first hand tracking data and the second hand tracking data being temporally overlapping, determining a first state of the first hand and a second state of the second hand, the first and second states each corresponding to one of an open hand state and a closed hand state;
interpreting a gesture based at least on the first and second states; and
controlling one or more aspects of the computing device based on the gesture interpreted.
